(19) United States
(12) Patent Application Publication
(10) Pub. No.: US 2026/0036729 A1
(43) Pub. Date: Feb. 5, 2026

(54) OPTICAL FILTER

(71) Applicant: AGC Inc., Tokyo (JP)

(72) Inventors: Takashi NAGATA, Tokyo (JP); Takahiro SAKAGAMI, Tokyo (JP); Kazuhiko SHIONO, Tokyo (JP)

(73) Assignee: AGC Inc., Tokyo (JP)

(21) Appl. No.: 19/355,063

(22) Filed: Oct. 10, 2025

Related U.S. Application Data
(63) Continuation of application No. PCT/JP2024/017257, filed on May 9, 2024.

(30) Foreign Application Priority Data
May 19, 2023 (JP) 2023-083282

(51) Int. Cl. G02B 5/20; G02B 5/28

(52) U.S. Cl. CPC G02B 5/208; G02B 5/282

(57) ABSTRACT

An optical filter includes: a light-absorbing material X_{700L} having a maximum absorption wavelength in a wavelength region longer than 700 nm; a light-absorbing material Y_{970S} having a maximum absorption wavelength in a wavelength region shorter than 970 nm; and a dielectric multilayer film, in which the optical filter satisfies all of spectral characteristics (i-1) to (i-4).

### CROSS-REFERENCE TO RELATED APPLICATIONS

This is a bypass continuation of International Patent Application No. PCT/JP2024/017257, filed on May 9, 2024, which claims priority to Japanese Patent Application No. 2023-083282, filed on May 19, 2023. The contents of these applications are hereby incorporated by reference in their entireties.

### TECHNICAL FIELD

The present invention relates to an optical filter that selectively transmits light in a visible light region and a specific near-infrared light region and shields light other than that in the regions.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter (see Patent Literature 1).

### CITATION LIST

### Patent Literature

Patent Literature 1: JP2006-10764A

### SUMMARY OF INVENTION

In recent years, since laser light including a partial region of 950 nm to 1,200 nm is used in a sensor in the imaging field, an optical filter that can transmit near-infrared light of such a sensing region and shield other near-infrared light that causes noise is required.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

A shift in a visible light transmission region or a region switched from a short wavelength side near-infrared light shielding region to a near-infrared light transmission region can be reduced by using an absorbing material such as a dye. On the other hand, it is difficult to reduce a shift in a region switched from the near-infrared light transmission region to the near-infrared light shielding region by the absorbing material. When the shift is large only in this region, a transmitted light amount of the near-infrared light is changed depending on the incident angle, and a ratio of captured light amounts of visible light and infrared light in the solid state image sensor is also changed depending on the incident angle. As a result, color reproducibility of a (color) image based on the visible light and reproducibility of a (monochrome) image based on the infrared light may be affected.

An object of the present invention is to provide an optical filter that has excellent transmittance for visible light and specific near-infrared light, excellent shielding properties for other near-infrared light, and a small shift of a spectral curve even at a high incident angle.

The present invention provides an optical filter having the following configuration.
[1] An optical filter including:
a light-absorbing material X_{700L} having a maximum absorption wavelength in a wavelength region longer than 700 nm;
a light-absorbing material Y_{970S} having a maximum absorption wavelength in a wavelength region shorter than 970 nm; and
a dielectric multilayer film, in which
the optical filter satisfies all of the following spectral characteristics (i-1) to (i-4):
(i-1) an average transmittance T_{420-650(0deg)AVE} is 75% or more in a spectral transmittance curve at a wavelength of 420 nm to 650 nm and an incident angle of 0 degrees, and an average transmittance T_{420-650(35 deg)AVE} is 75% or more in a spectral transmittance curve at a wavelength of 420 nm to 650 nm and an incident angle of 35 degrees,
(i-2) an average transmittance T_{710-950(0 deg)AVE} is 1% or less in a spectral transmittance curve at a wavelength of 710 nm to 950 nm and an incident angle of 0 degrees, and an average transmittance T_{710-950(35 deg)AVE} is 1% or less in a spectral transmittance curve at a wavelength of 710 nm to 950 nm and an incident angle of 35 degrees,
(i-3) a maximum transmittance T_{950-1200(0 deg)MAX} is 60% or more in a spectral transmittance curve at a wavelength of 950 nm to 1,200 nm and an incident angle of 0 degrees, and a maximum transmittance T_{950-1200(35 deg)MAX} is 50% or more in a spectral transmittance curve at a wavelength of 950 nm to 1,200 nm and an incident angle of 35 degrees, and
(i-4)|λ_{IRS(0 deg)(50%)}−λ_{IRS(35 deg)(50%)}|≤15 nm is satisfied, where
λ_{IRS(0 deg)(50%)} is a wavelength at which a transmittance is 50% in a wavelength region shorter than λ_{950-1200 (0 deg)MAX} and at an incident angle of 0 degrees,
λ_{IRS(35 deg)(50%)} is a wavelength at which a transmittance is 50% in the wavelength region shorter than λ_{950-1200 (0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

According to the present invention, an optical filter that has excellent transmittance for visible light and specific near-infrared light and excellent shielding properties for other near-infrared light even at a high incident angle can be provided. The optical filter according to the present invention is particularly an optical filter in which transmittance in a near-infrared light region of 950 nm to 1,200 nm, which is a sensing wavelength region, is excellent even at a high incident angle, a spectral transmittance curve of a boundary region between such a transmission region and a wavelength region on a long wavelength side to be shielded is hardly shifted depending on an incident angle, and which is hardly affected by the incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating a spectral transmittance curve of a light-absorbing glass A.

FIG. 4 is a diagram illustrating a spectral transmittance curve of a light-absorbing layer of Example 1-1.

FIG. 5 is a diagram illustrating spectral transmittance curves and spectral reflectance curves (on dielectric multilayer film A side) of an optical filter in Example 2-1.

FIG. 6 is a diagram illustrating spectral reflectance curves (on dielectric multilayer film B side) and an absorption loss amount of the optical filter in Example 2-1.

FIG. 7 is a diagram illustrating spectral transmittance curves and spectral reflectance curves (on dielectric multilayer film A side) of an optical filter in Example 2-2.

FIG. 8 is a diagram illustrating spectral reflectance curves (on dielectric multilayer film B side) and an absorption loss amount of the optical filter in Example 2-2.

FIG. 9 is a diagram illustrating spectral transmittance curves and spectral reflectance curves (on dielectric multilayer film A side) of an optical filter in Example 2-3.

FIG. 10 is a diagram illustrating spectral reflectance curves (on dielectric multilayer film B side) and an absorption loss amount of the optical filter in Example 2-3.

FIG. 11 is a diagram illustrating spectral transmittance curves and spectral reflectance curves (on dielectric multilayer film A side) of an optical filter in Example 2-4.

FIG. 12 is a diagram illustrating spectral reflectance curves (on dielectric multilayer film B side) and an absorption loss amount of the optical filter in Example 2-4.

FIG. 13 is a diagram illustrating spectral transmittance curves and spectral reflectance curves (on dielectric multilayer film A side) of an optical filter in Example 2-5.

FIG. 14 is a diagram illustrating spectral reflectance curves (on dielectric multilayer film B side) and an absorption loss amount of the optical filter in Example 2-5.

### DESCRIPTION OF EMBODIMENTS

Hereinafter, embodiments of the present invention will be described.

In the present description, a near-infrared ray absorbing dye may be abbreviated as an “NIR dye”, and an ultraviolet ray absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, an internal transmittance is a transmittance obtained by subtracting an influence of interface reflection from a measured transmittance, which is represented by a formula of {measured transmittance (incident angle of 0 degrees)/(100−reflectance (incident angle of 5 degrees))}×100.

In the present description, the optical density represents a value converted from the internal transmittance by the following formula.

$$Optical density at wavelength of λ nm = - log 10 ( {iT}_{λ} / 100 )$$

iT_{λ}: internal transmittance at an incident angle of 0 degrees at a wavelength of λ nm

In the present description, transmittance of glass and a spectrum of transmittance of an absorption layer including a case where a dye is contained in a resin are both “internal transmittance” even when described as “transmittance”. On the other hand, transmittance measured by dissolving a dye in a solvent such as dichloromethane, transmittance of a dielectric multilayer film, and transmittance of an optical filter including the dielectric multilayer film are measured transmittance.

In the present description, a transmittance of, for example, 90% or more in a specific wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance in the wavelength region is 1% or less. The same applies to the internal transmittance. An average transmittance and an average internal transmittance in the specific wavelength region are the arithmetic mean of a transmittance and an internal transmittance per 1 nm in the wavelength region.

Spectral characteristics can be measured by using an ultraviolet-visible spectrophotometer.

In the present description, the symbol “−” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “the filter”) includes: a light-absorbing material X_{700L} having a maximum absorption wavelength in a wavelength region longer than 700 nm; a light-absorbing material Y_{970S} having a maximum absorption wavelength in a wavelength region shorter than 970 nm; and a dielectric multilayer film.

Reflection characteristics of the dielectric multilayer film and absorption characteristics of the light-absorbing material X_{700L} and the light-absorbing material Y_{970S} allow the optical filter as a whole to achieve excellent transmittance in a visible light region and a specific near-infrared light region, and excellent shielding properties in another near-infrared light region.

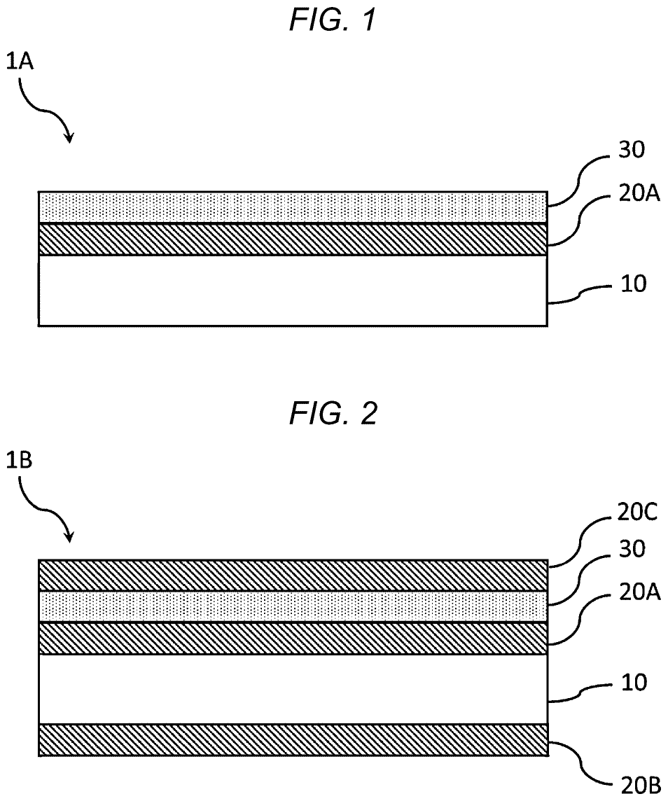

An example of a configuration of the filter will be described with reference to the drawings. FIGS. 1 and 2 are cross-sectional views schematically illustrating examples of the optical filter according to one embodiment.

An optical filter 1A illustrated in FIG. 1 is an example including a support 10 formed of the light-absorbing material Y_{970S}, a dielectric multilayer film 20A laminated on one main surface of the support 10, and a light-absorbing layer 30 containing the light-absorbing material X_{700L} provided on a surface of the dielectric multilayer film 20A.

An optical filter 1B illustrated in FIG. 2 is an example further including a dielectric multilayer film 20B laminated on the other main surface of the support 10.

The optical filter according to an embodiment of the present invention satisfies all of the following spectral characteristics (i-1) to (i-4).
(i-1) An average transmittance T_{420-650(0 deg)AVE} is 75% or more in a spectral transmittance curve at a wavelength of 420 nm to 650 nm and an incident angle of 0 degrees, and an average transmittance T_{420-650(35 deg)AVE} is 75% or more in a spectral transmittance curve at a wavelength of 420 nm to 650 nm and an incident angle of 35 degrees.
(i-2) An average transmittance T_{710-950(0 deg)AVE} is 1% or less in a spectral transmittance curve at a wavelength of 710 nm to 950 nm and an incident angle of 0 degrees, and an average transmittance T_{710-950(35 deg)AVE} is 1% or less in a spectral transmittance curve at a wavelength of 710 nm to 950 nm and an incident angle of 35 degrees.
(i-3) A maximum transmittance T_{950-1200(0 deg)MAX} is 60% or more in a spectral transmittance curve at a wavelength of 950 nm to 1,200 nm and an incident angle of 0 degrees, and a maximum transmittance T_{950-1200(35 deg)MAX} is 50% or more in a spectral transmittance curve at a wavelength of 950 nm to 1,200 nm and an incident angle of 35 degrees.
(i-4) |λ_{IRS(0 deg)(50%)}−λ_{IRS(35 deg)(50%)}|≤15 nm is satisfied, where
λ_{IRS(0 deg)(50%)} is a wavelength at which a transmittance is 50% in a wavelength region shorter than λ_{950-1200(0 deg)MAX} and at an incident angle of 0 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

The filter satisfying all of the spectral characteristics (i-1) to (i-4) is a dual passband filter excellent in transmittance of visible light as shown in the characteristic (i-1), excellent in transmittance of specific near-infrared light as shown in the characteristic (i-3), excellent in shielding properties of other near-infrared light as shown in the characteristics (i-2), and excellent in transmission band stability of near-infrared light as shown in the characteristic (i-4).

Satisfying the spectral characteristic (i-1) means that a transmittance in a visible light region of 420 nm to 650 nm is excellent even at a high incident angle.

The average transmittance T_{420-650(0 deg)AVE} is preferably 77% or more, and more preferably 79% or more.

The average transmittance T_{420-650(35 deg)AVE} is preferably 77% or more, and more preferably 79% or more.

In addition, in order to satisfy the spectral characteristic (i-1), for example, the dielectric multilayer film that has excellent transmittance in the visible light region, the light-absorbing material λ_{700L}, and the light-absorbing material Y_{970S} may be used.

Satisfying the spectral characteristic (i-2) means that shielding properties in a near-infrared light region of 710 nm to 950 nm are excellent even at a high incident angle.

The average transmittance T_{710-950(0 deg)AVE} is preferably 0.8% or less, and more preferably 0.6% or less.

The average transmittance T_{710-950(35 deg)AVE} is preferably 0.8% or less, and more preferably 0.6% or less.

In addition, in order to satisfy the spectral characteristic (i-2), for example, light may be shielded by an absorption ability of the light-absorbing material λ_{700L} and the light-absorbing material Y_{970S}.

Satisfying the spectral characteristic (i-3) means that a transmittance in a near-infrared light region of 950 nm to 1,200 nm is excellent even at a high incident angle.

The maximum transmittance T_{950-1200(0 deg)MAX} is preferably 65% or more, and more preferably 70% or more.

The maximum transmittance T_{950-1200(35 deg)MAX} is preferably 55% or more, and more preferably 60% or more.

In addition, in order to satisfy the spectral characteristic (i-3), for example, a dielectric multilayer film excellent in transmittance in the near-infrared light region of 950 nm to 1,200 nm may be used.

Satisfying the spectral characteristic (i-4) means that a spectral curve in a wavelength region of 950 nm to 1,200 nm is less likely to shift in a wavelength region shorter than a maximum absorption wavelength even at a high incident angle.

|λ_{IRS(0 deg)(50%)}−λ_{IRS(35 deg)(50%)}| is preferably 12 nm or less, more preferably 10 nm or less, and further preferably 8 nm or less.

In order to satisfy the spectral characteristic (i-4), for example, an ytterbium-containing glass to be described later may be used as the light-absorbing material Y_{970S}, and light may be shielded by the absorption ability of the light-absorbing material Y_{970S}.

The optical filter according to an embodiment of the present invention preferably further satisfies the following spectral characteristic (i-5).
(i-5) 10/[λ_{IRS(0 deg)(45%)}−λ_{IRS(0 deg)(55%)]}|≥1.0 is satisfied, where
λ_{IRS(0 deg)(55%)} is a wavelength at which a transmittance is 55% in the wavelength region shorter than λ_{950-1200(0 deg)MAX} and at an incident angle of 0 degrees,
λ_{IRS(0 deg)(45%)} is a wavelength at which a transmittance is 45% in the wavelength region shorter than λ_{950-1200(0 deg)MAX} and at an incident angle of 0 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

The above-mentioned relational expression in the spectral characteristic (i-5) means a degree of fall of a spectral transmittance curve in a wavelength region of 950 nm to 1,200 nm (an inclination of a cutoff of a near-infrared band), which is switched from the near-infrared light region to be transmitted to a short wavelength side in the near-infrared light region to be shielded. From the viewpoint of efficiently capturing light, the steeper the spectral curve in a boundary region between a transmission region and a shielding region is, the more ideal. It means that when the above-mentioned relational expression (inclination) in the spectral characteristic (i-5) is 1.0 or more, a transmittance of near-infrared light to be transmitted is excellent.

The above-mentioned relational expression (inclination) in the spectral characteristic (i-5) is more preferably 1.1 or more, and further preferably 1.2 or more.

In order to satisfy the spectral characteristic (i-5), for example, an ytterbium-containing glass to be described later may be used as the light-absorbing material Y_{970S}, and light may be shielded by the absorption ability of the light-absorbing material Y_{970S}.

The optical filter according to an embodiment of the present invention preferably further satisfies the following spectral characteristics (i-6) to (i-8).
(i-6) 10 nm≤|λ_{IRL(0 deg)(50%)}−λ_{IRS(0 deg)(50%)}|≤100 nm is satisfied, where
λ_{IRL(0 deg)(50%)} is a wavelength at which a transmittance is 50% in a wavelength region longer than λ_{950-1200(0 deg)MAX} and at an incident angle of 0 degrees,
λ_{IRS(0 deg)(50%)} is a wavelength at which a transmittance is 50% in the wavelength region shorter than λ_{950-1200(0 deg)MAX} and at an incident angle of 0 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-7) 20 nm≤|λ_{IRL(35 deg)(50%)}−λ_{IRS(35 deg)(50%)}|≤100 nm is satisfied, where
λ_{IRL(35 deg)(50%)} is a wavelength at which a transmittance is 50% in the wavelength region longer than λ_{950-1200(0 deg)MAX} and at an incident angle of 35 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-8) λ_{IRL(0 deg)(50%)}, λ_{IRS(0 deg)(50%)}, λ_{IRL(35 deg)(50%)}, and λ_{IRS(35 deg)(50%)} satisfy the following relational expression:

$$\vert [ {λ}_{I R L ( 35 deg ) ( 50 \% )} - {λ}_{I R S ( 35 deg ) ( 50 \% )} ] - [ {λ}_{I R L ( 0 deg ) ( 50 \% )} - {λ}_{I R S ( 0 deg ) ( 50 \% )} ] \vert \leq 70 nm$$

The spectral characteristics (i-6) to (i-8) are provisions relating to bandwidths of a near-infrared light transmission band.

The spectral characteristic (i-6) is an index of a bandwidth at an incident angle of 0 degrees, the spectral characteristic (i-7) is an index of a bandwidth at an incident angle of 35 degrees, and the spectral characteristic (i-8) is an index of a difference between the bandwidths at the incident angles of 0 degrees and 35 degrees.

The bandwidth is preferably within a specific range from the viewpoint of allowing necessary near-infrared light to be transmitted and the viewpoint of allowing unnecessary near-infrared light to be shielded.

Therefore, in the spectral characteristic (i-6), |λ_{IRL(0 deg)(50%)}−λ_{IRS(0 deg)(50%)}| is more preferably 20 nm or more and 90 nm or less.

In the spectral characteristic (i-7), ♂λ_{IRL(35 deg)(50%)}−λ_{IRS(35 deg)(50%)} is more preferably 30 nm or more and 90 nm or less.

In the spectral characteristic (i-8), |[λ_{IRL(35 deg)(50%)}−λ_{IRS(35 deg)(50%)}]−[λ_{IRL(0 deg)(50%)}−λ_{IRS(0 deg)(50%)}]| is more preferably 60 nm or less.

In order to satisfy the spectral characteristics (i-6) to (i-8), for example, the ytterbium-containing glass to be described later may be used as the light-absorbing material Y_{970S}, and shielding light by the absorption ability of the light-absorbing material Y_{970S} and shielding light by the absorption ability of the light-absorbing material λ_{700L} may be combined.

The optical filter according to an embodiment of the present invention preferably further satisfies the following spectral characteristics (i-9) and (i-10).
(i-9) 10 (%·nm)≤IRP-A_{(0 deg)}≤100 (%·nm) is satisfied, where
IRP-A_{(0 deg)} is an integral value of a transmittance in a wavelength band in which the transmittance is 20% or more in the spectral transmittance curve at a wavelength of 950 nm to 1,200 nm and an incident angle of 0 degrees, and
(i-10) 10 (%·nm)≤IRP-A_{(3 5deg)}≤100 (%·nm) is satisfied, where IRP-A_{(35 deg)} is an integral value of a transmittance in a wavelength band in which the transmittance is 20% or more in a spectral transmittance curve at a wavelength of 950 nm to 1,200 nm and an incident angle of 35 degrees.

The spectral characteristics (i-9) and (i-10) are provisions relating to an area of a band in which the transmittance is 20% or more at each of the incident angles of 0 degrees and 35 degrees in the near-infrared light transmission region, and such an area is an index of an amount of near-infrared light to be transmitted. Specifically, IRP-A_{(0deg)} is obtained by calculating an integral value of a transmittance in a wavelength band in which the transmittance is 20% or more at an incident angle of 0 degrees. IRP-A_{(35deg)} is similarly calculated based on transmittance and a wavelength at an incident angle of 35 degrees.

IRP-A_{(0deg)} is more preferably 20 (%·nm) or more, and is more preferably 90 (%·nm) or less.

IRP-A_{(35deg)} is more preferably 20 (%·nm) or more, and is more preferably 90 (%·nm) or less.

Further, IRP-A_{(0deg)} and IRP-A_{(35deg)} more preferably satisfy the following relational expression.

$$0.5 \leq IRP - {A}_{( 35 deg )} / IRP - {A}_{( 0 deg )} \leq 1.1$$

IRP-A_{(35deg)}/IRP-A_{(0deg)} means a ratio of an amount of near-infrared light at an incident angle of 0 degrees to an amount of near-infrared light at an incident angle of 35 degrees, and it is preferable that IRP-A_{(35deg)}/IRP-A_{(0deg)} be in the above-mentioned range because an influence of the incident angle on the efficiency of capturing the near-infrared light by the optical filter is small.

IRP-A_{(35deg)}/IRP-A_{(0deg)} is more preferably 0.6 or more, and is more preferably 1.0 or less.

The optical filter according to an embodiment of the present invention preferably further satisfies the following spectral characteristic (i-11).
(i-11) 0.5≤[IRP-A_{(35deg)}/VIS-A_{(35deg)}]/[IRP-A_{(0deg)}/VIS-A_{(0deg)}]≤1.1 is satisfied, where
VIS-A_{(0deg)} is an integral value of a transmittance in a wavelength band in which the transmittance is 20% or more in the spectral transmittance curve at a wavelength of 420 nm to 650 nm and an incident angle of 0 degrees,
VIS-A_{(35deg)} is an integral value of a transmittance in a wavelength band in which the transmittance is 20% or more in a spectral transmittance curve at a wavelength of 420 nm to 650 nm and an incident angle of 35 degrees,
IRP-A_{(0deg)} is an integral value of a transmittance in a wavelength band in which the transmittance is 20% or more in the spectral transmittance curve at a wavelength of 950 nm to 1,200 nm and an incident angle of 0 degrees, and
IRP-A_{(35deg)} is an integral value of a transmittance in a wavelength band in which the transmittance is 20% or more in a spectral transmittance curve at a wavelength of 950 nm to 1,200 nm and an incident angle of 35 degrees.

In (i-11), VIS-A_{(0deg)} and VIS-A_{(35deg)} are provisions relating to an area of a band in which the transmittance is 20% or more at each of the incident angles of 0 degrees and 35 degrees in the visible light, and such an area is an index of an amount of visible light to be transmitted. IRP-A_{(0deg)} and IRP-A_{(35deg)} are indices of the amount of near-infrared light to be transmitted as described in the spectral characteristics (i-9) and (i-10).

[IRP-A_{(35deg)}/VIS-A_{(35deg)}]/[IRP-A_{(0deg)}/VIS-A_{(0deg)}] in the spectral characteristic (i-11) means a ratio of an area ratio at an incident angle of 0 degrees in a visible light transmission band and a near-infrared light transmission band and an area ratio at an incident angle of 35 degrees in the visible light transmission band and the near-infrared light transmission band, and when the ratio is within a specific range, an influence of the incident angle on a ratio of the efficiency of capturing visible light and near-infrared light by the optical filter is reduced to be small. This is preferable because the color reproducibility when a visible light (color) image is generated by the solid state image sensor can be enhanced and color shading can be prevented. The ratio is more preferably 0.6 or more, and is more preferably 1.0 or less.

The optical filter according to an embodiment of the present invention preferably further satisfies the following spectral characteristic (i-12).
(i-12) |λ_{IRR(5 deg)(50%)}−λ_{IRS(0 deg)(50%)}|≥20 nm is satisfied, where
λ_{IRS(0 deg)(50%)} is a wavelength at which a transmittance is 50% in the wavelength region shorter than λ_{950-1200 (0 deg)MAX} and at an incident angle of 0 degrees,
λ_{IRR(5 deg)(50%)} is a wavelength at which a reflectance is 50% in a wavelength region longer than 950 nm and at an incident angle of 5 degrees in a spectral reflectance curve at a wavelength of 950 nm to 1,200 nm and an incident angle of 5 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

The spectral characteristic (i-12) means that the near-infrared light transmission band and a near-infrared light reflection band are sufficiently separated from each other. It is preferable that in such a band, light be shielded by the absorption ability of the light-absorbing material Y_{970S} rather than the reflection characteristics of the dielectric multilayer film.
   |λ_{IRR(5 deg)(50%)}−λ_{IRS(0 deg)(50%)}| is more preferably 30 nm or more, and further preferably 40 nm or more.

### <Light-Absorbing Material Y_{970S}>

The filter includes the light-absorbing material Y_{970S} having a maximum absorption wavelength in a wavelength region shorter than 970 nm. Accordingly, it is possible to compensate for a region where light is not shielded by the reflection characteristics of the dielectric multilayer film.

The light-absorbing material Y_{970S} preferably satisfies the following spectral characteristics (iii-1) and (iii-2).
(iii-1) Maximum optical density at wavelength of 900 nm to 1,000 nm>0.6.
(iii-2) A wavelength at which a transmittance is 50% on a side of a wavelength longer than the maximum optical density at a wavelength of 900 nm to 1,000 nm is in a range of 950 nm to 1,050 nm.

The spectral characteristic (iii-1) means that a fluctuation of the spectral characteristic is reduced regardless of the incident angle. The maximum optical density at the wavelength of 900 nm to 1,000 nm is more preferably 0.65 or more.

The spectral characteristic (ii-2) means that the fluctuation of the spectral characteristic can be reduced by combining dielectric multilayer films. The wavelength at which the transmittance is 50% on the side of a wavelength longer than the maximum optical density at the wavelength of 900 nm to 1,000 nm is more preferably 945 nm to 1,000 nm.

The light-absorbing material Y_{970S} is not limited as long as it is a material capable of obtaining the above-mentioned spectral characteristic, and for example, an inorganic material containing ytterbium is preferable, and a single crystal and a polycrystalline sintered body such as Yb₂O₃, Yb:YAG (Yttrium Aluminum Garnet), Yb:YVO₄, and the like, a glass containing ytterbium, or the like is considered. Among those, a glass containing ytterbium is more preferable from the viewpoint of processability, stability of material quality, and ease of adjusting physical properties. When the light-absorbing material Y_{970S} is such a material, the above-mentioned spectral characteristics (iii-1) and (iii-2) are easily satisfied.

The ytterbium-containing glass preferably has a maximum absorption wavelength of 940 nm to 970 nm.

It is preferable that in the ytterbium-containing glass, an average of internal transmittance at a wavelength of 450 nm to 600 nm and an incident angle of 0 degrees be 60% or more, more preferably 80% or more, and still more preferably 90% or more.

It is preferable that in the ytterbium-containing glass, an average of internal transmittance at a wavelength of 700 nm to 800 nm and an incident angle of 0 degrees be 60% or more, more preferably 80% or more, and still more preferably 90% or more.

The ytterbium-containing glass is excellent in transmittance in the visible light region and transmittance in a region from visible light to near-infrared light of about 800 nm, and absorbs light in a near-infrared light region of 850 nm or more, particularly 900 nm to 950 nm. In addition, since light is shielded by the absorption characteristic, light-shielding properties are less likely to be affected by the incident angle unlike the dielectric multilayer film. Therefore, by using the ytterbium-containing glass, when the sensing wavelength region is particularly 950 nm to 1,200 nm, an optical filter is obtained in which transmittance in the near-infrared light region is excellent even at a high incident angle, a spectral transmittance curve of a boundary region between such a transmission region and a wavelength region of 950 nm or more to be shielded is hardly shifted depending on an incident angle, and which is hardly affected by the incident angle.

Examples of the ytterbium-containing glass include a glass having any of the following compositions.
(1) Glass containing Yb₂O₃ and B₂O₃ as essential components in terms of mol % based on an oxide, in which a content of Yb₂O₃ is 10 mol % to 60 mol %, and a content of B₂O₃ is 10 mol % to 70 mol %.
(2) Glass further containing SiO₂ as an essential component in addition to (1), in which a content of SiO₂ is 5 mol % to 35 mol %.
(3) Glass further containing La₂O₃ as an essential component in addition to (1) and (2), in which a content of La₂O₃ is 1 mol % to 20 mol %.

As the ytterbium-containing glass, a commercially available product may be used, and the ytterbium-containing glass can be manufactured by known methods disclosed in Japanese Laid-Open Patent Publication No. S61-163138, Japanese Laid-Open Patent Publication No. S56-78447, and the like.

In addition, as the ytterbium-containing glass, there may be used chemically strengthened glass obtained by exchanging, in glass having a composition containing an alkali metal, alkali metal ions (for example, Li ions and Na ions) having a small ionic radius present on a main surface of a glass plate with alkali ions having a larger ionic radius (for example, Na ions or K ions with respect to Li ions and K ions with respect to Na ions) by ion exchange at a temperature equal to or lower than a glass transition point.

The ytterbium-containing glass has a thickness of preferably 3 mm or less, more preferably 2 mm or less, and further preferably 1 mm or less from the viewpoint of ease of optical design when incorporated into a camera module, and the thickness is preferably 0.1 mm or more from the viewpoint of device strength and a necessity of obtaining desired optical characteristics.

### <Light-absorbing Material λ_{700L} and Light-absorbing Layer>

The filter includes the light-absorbing material λ_{700L} having a maximum absorption wavelength in a wavelength region longer than 700 nm. Accordingly, it is possible to compensate for a region where light is not shielded by the reflection characteristics of the dielectric multilayer film.

The optical filter preferably includes a light-absorbing layer containing the light-absorbing material λ_{700L}. The optical filter including such a light-absorbing layer preferably satisfies both the following spectral characteristics (ii-1) and (ii-2).

When a light is incident from a dielectric multilayer film side, an absorption loss amount_{X} at a wavelength of X nm is defined as follows.

$${( Absorption loss amount )}_{X} [ \% ] = 100 - ( transmittance at incident angle of 0 degrees ) - ( reflectance at incident angle of 5 degrees ) .$$

(ii-1) A maximum value of an absorption loss amount₆₀₀₋₈₃₀ at a wavelength of 600 nm to 830 nm is 85 or more.
(ii-2) An integral value of the absorption loss amount₆₀₀₋₈₃₀ at a wavelength of 600 nm to 830 nm is 5,000 or more.

The absorption loss amount_{X} is an index indicating a shielding degree corresponding to absorption characteristics at a wavelength of X nm, and the larger a numerical value thereof is, the more the light of the wavelength X is shielded by absorption.

An integral value of an absorption loss amount_{X-Y} is a value obtained by obtaining and summing each absorption loss amount for each wavelength of 1 nm in a range of X nm to Y nm, and the larger the numerical value is, the more the wavelength region of X nm to Y nm is shielded by absorption.

Satisfying the spectral characteristic (ii-1) means that S/N other than a desired wavelength can be prevented.

Satisfying the spectral characteristic (ii-2) means that the spectral characteristic can be achieved by absorption.

The maximum value of the absorption loss amount₆₀₀₋₈₃₀ is more preferably 87 or more, and further preferably 90 or more.

The integral value of the absorption loss amount₆₀₀₋₈₃₀ is more preferably 5,500 or more, and further preferably 6,000 or more.

In order to satisfy the spectral characteristics (ii-1) and (ii-2), for example, a light-absorbing material λ_{700L} (to be described in detail later) having a maximum absorption wavelength in a range of 700 nm to 800 nm is used.

The light-absorbing material λ_{700L} is preferably a dye having a maximum absorption wavelength in a wavelength region of 700 nm to 800 nm in dichloromethane (hereinafter, also referred to as an “NIR dye”). By including such a dye, the light-absorbing layer can absorb a wide range of light in the near-infrared light absorption band centered at 720 nm, and can easily achieve both the visible light transmittance at 450 nm and the near-infrared light shielding properties at 720 nm.

From the viewpoint of being able to absorb a wide range of light in the near-infrared region, a combination of two kinds of dyes having different maximum absorption wavelengths and existing in a region of 700 nm to 800 nm, preferably a combination of a dye having a maximum absorption wavelength in 700 nm to 740 nm and a dye having a maximum absorption wavelength in 740 nm to 800 nm may be used.

The absorption layer is preferably a resin film containing the dye and the resin.

The NIR dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The NIR dye preferably contains at least one dye selected from a squarylium dye, a phthalocyanine dye, and a cyanine dye. Among these NIR dyes, a squarylium dye and a cyanine dye are preferable from the viewpoint of spectroscopy, and a phthalocyanine dye is preferable from the viewpoint of durability.

A content of the NIR dye in the absorption layer is preferably 0.1 parts by mass to 25 parts by mass, and more preferably 0.3 parts by mass to 15 parts by mass with respect to 100 parts by mass of the resin. When two or more compounds are combined, the above-mentioned content is a sum of respective compounds.

The absorption layer may include other dyes in addition to the above-mentioned NIR dye. Examples of the other dyes preferably include a dye (UV dye) having a maximum absorption wavelength in 370 nm to 440 nm in the resin. Accordingly, a near ultraviolet region can be efficiently shielded.

Examples of the UV dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among them, the merocyanine dye is particularly preferred. These dyes may be used alone, or may be used in combination of two or more kinds thereof.

The light-absorbing layer is preferably laminated on at least one main surface of the support. The support may be an organic material or an inorganic material. Here, it is preferable that the light-absorbing material Y_{970S} have both a near-infrared light absorption ability and a function as a support if the light-absorbing material Y_{970S} is an inorganic material.

The resin in the light-absorbing layer is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the light-absorbing layer, one or more kinds of resins selected from a polyimide resin, a polycarbonate resin, a polyester resin, and an acrylic resin are preferable.

In a case where a plurality of compounds are used as the NIR dye or other dyes, those compounds may be included in the same light-absorbing layer or may be included in different absorption layers.

The light-absorbing layer can be formed by dissolving or dispersing a dye, a resin or raw material components of the resin, and respective components blended as necessary in a solvent to prepare a coating solution, applying the coating solution to a support, drying the coating solution, and further curing the coating solution as necessary. When the light-absorbing material Y_{970S} is an inorganic material, the support may be the light-absorbing material Y_{970S}, or may be a peelable support used only when the light-absorbing layer is formed. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. When the coating solution contains a raw material component of the transparent resin, a curing process such as thermal curing or photocuring is further performed.

The absorption layer can also be manufactured into a film shape by extrusion molding. The filter can be manufactured by laminating the obtained film-shaped absorption layer on the support (for example, light-absorbing material Y_{970S}) and integrating those by thermal press fitting or the like.

The absorption layer may be provided in the optical filter by one layer or two or more layers. In a case where the absorption layer is provided by two or more layers, each of the layers may have the same configuration or a different configuration, and two or more layers may be stacked on or above one surface of the dielectric multilayer film even when the absorption layers are formed on or above each of the surfaces of the dielectric multilayer films.

A thickness of the absorption layer is 10 μm or less and preferably 5 μm or less from the viewpoint of in-plane film thickness distribution and appearance quality in a substrate after coating, and is preferably 0.5 μm or more from the viewpoint of exhibiting desired spectral characteristics at an appropriate dye concentration. In a case where the optical filter has two or more layers of absorption layers, a total thickness of each of the absorption layers is preferably within the above-mentioned range.

### <Dielectric Multilayer Film>

The filter includes a dielectric multilayer film. The filter may have one or more dielectric multilayer films, at least one of which is preferably designed as a reflective film (hereinafter, also referred to as an “NIR reflective film”) that reflects a part of near-infrared light. The other one of the dielectric multilayer films may be designed as a reflective film having a reflection region in another near-infrared region, or as an antireflection film.

The filter preferably includes at least two NIR reflective films having different reflective regions.

The filter preferably includes a substrate including a light-absorbing material Y_{970S}, a dielectric multilayer film A provided on or above one main surface of the substrate, a dielectric multilayer film B provided on or above the other main surface of the substrate, and a light-absorbing layer provided on the one main surface side of the substrate and containing a light-absorbing material λ_{700L}.

It is preferable that the NIR reflective film have, for example, wavelength selectivity of transmitting visible light, transmitting near-infrared light in a transmission region of the light-absorbing material λ_{700L} and the light-absorbing material Y_{970S}, and mainly reflecting other near-infrared light. The NIR reflective films may be further appropriately designed to have a specification further reflecting light in a wavelength range other than the near-infrared light, for example, near ultraviolet light.

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band. An equivalent film to be described later refers to, for example, a film optically equivalent by combining two or more types of films having a high refractive index and a low refractive index instead of one film.

The dielectric multilayer film A preferably satisfies all of the following characteristics (iv-1), (iv-2), and (iv-3).
(iv-1) the dielectric multilayer film A comprises three or more laminated structures, each of the laminated structures includes a high refractive index layer H_{A} including a high refractive index material having a refractive index of 1.9 or more and 3.0 or less at a wavelength of 500 nm and a medium refractive index layer M_{A} including a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{A}/medium refractive index layer M_{A}), and
(here, in a case where the medium refractive index layer M_{A} includes the high refractive index layer H_{A} and a low refractive index layer L_{A} including a low refractive index material having a refractive index of 1.3 or more and 1.7 or less at a wavelength of 500 nm, the medium refractive index layer M_{A} is treated as an equivalent film).
(iv-2) the dielectric multilayer film A includes a laminated structure represented by (aₙQH_{A}/bₙQM_{A})
where QH_{A} is a QWOT of the high refractive index layer H_{A} at a wavelength of 500 nm and QM_{A} is a QWOT of the medium refractive index layer M_{A} at a wavelength of 500 nm, and
here, an average value of aₙ is 1.2 or more and 2.7 or less, and an average value of bₙ is 1.1 or more and 2.2 or less.
(iv-3) The number of laminated layers is in a range of 1 to 60.

When the dielectric multilayer film A satisfies the characteristics (iv-1), (iv-2), and (iv-3), a reflective layer having a characteristic of cutting a visible band and a side of a wavelength longer than a sensing band is obtained.

The laminated structures (H_{A}/M_{A}) may be continuous with each other or separated from each other. Please note that the laminated structure (H_{A}/M_{A}) has the same meaning as the structure represented by (high refractive index layer H_{A}/medium refractive index layer M_{A}).

The number of the laminated structures represented by (H_{A}/M_{A}) is more preferably 5 or more.

The symbols aₙ and bₙ are coefficients in each basic unit, and represent how many times the physical film thickness of the film in each basic unit is the QWOT (Quarter wave of optical thickness: optical film thickness of ¼ wavelengths). Therefore, aₙQH_{A} and bₙQM_{A} each represent an optical film thickness of each film.

The average value of aₙ is more preferably 1.2 or more and 2.5 or less, and further preferably 1.2 or more and 2.4 or less, and the average value of bₙ is more preferably 1.1 or more and 2.4 or less, and further preferably 1.1 or more and 2.3 or less.

The number of laminated layers of the dielectric multilayer film A is more preferably 20 to 60, and further preferably 40 to 60.

The dielectric multilayer film B preferably satisfies all of the following characteristics (v-1), (v-2), and (v-3).
(v-1) The dielectric multilayer film B includes three or more laminated structures, each of the laminated structures includes a high refractive index layer H_{B} including a high refractive index material having a refractive index of 1.9 or more and 3.0 or less at a wavelength of 500 nm and a medium refractive index layer M_{B} including a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{B}/medium refractive index layer M_{B}).

The medium refractive index layer M_{B} is treated as an equivalent film in a case where the medium refractive index layer M_{B} includes the high refractive index layer H_{B} and a low refractive index layer L_{B} including a low refractive index material having a refractive index of 1.3 or more and 1.7 or less at a wavelength of 500 nm.
(v-2) The dielectric multilayer film B includes a laminated structure represented by (cₙQH_{B}/dₙQM_{B})
where QH_{B} is a QWOT of the high refractive index layer H_{B} at a wavelength of 500 nm and QM_{B} is a QWOT of the medium refractive index layer M_{B} at a wavelength of 500 nm.

An average value of cₙ is 1.9 or more and 5.0 or less and an average value of dₙ is 1.2 or more and 2.9 or less.
(v-3) The number of laminated layers is in a range of 1 to 60.

When the dielectric multilayer film B satisfies the characteristics (v-1), (v-2), and (v-3), a reflective layer having a characteristic of cutting a visible band and a side of a wavelength shorter than a sensing band is obtained.

The laminated structures (H_{B}/M_{B}) may be continuous with each other or separated from each other. Please note that the laminated structure (H_{B}/M_{B}) has the same meaning as the structure represented by (high refractive index layer H_{B}/medium refractive index layer M_{B}). The number of the laminated structures represented by (H_{B}/M_{B}) is more preferably 5 or more.

The symbols cₙ and dₙ are coefficients in each basic unit, and represent how many times the physical film thickness of the film in each basic unit is the QWOT (Quarter wave of optical thickness: optical film thickness of ¼ wavelengths). Therefore, cₙQH_{B} and dₙQM_{B} each represent an optical film thickness of each film.

The average value of cₙ is more preferably 2.0 or more and 5.0 or less, and further preferably 2.1 or more and 5.0 or less, and the average value of dₙ is more preferably 1.21 or more and 2.9 or less, and further preferably 1.22 or more and 2.9 or less.

The number of laminated layers of the dielectric multilayer film B is more preferably 10 to 60, and further preferably 20 to 60.

The dielectric multilayer film A satisfying the above-mentioned characteristics is a film designed to mainly reflect light in a wavelength region of 1,050 nm to 1,200 nm.

The dielectric multilayer film B satisfying the above-mentioned characteristics is a film designed to mainly reflect light in a wavelength region of 800 nm to 900 nm.

The refractive index of the high refractive index material at a wavelength of 500 nm is preferably 1.9 or more and 3.0 or less, more preferably 1.9 or more and 2.8 or less, and further preferably 1.9 or more and 2.6 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among them, TiO₂ is preferable from the viewpoint of reproducibility in film formability and refractive index, stability, and the like.

The medium refractive index material is a material having a refractive index relatively lower than that of the high refractive index layer material, and the refractive index at a wavelength of 500 nm is preferably 1.5 or more and 2.0 or less, more preferably 1.5 or more and 1.95 or less, and further preferably 1.5 or more and 1.9 or less. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck. Among them, Al₂O₃-based compounds and mixtures of Al₂O₃ and ZrO₂ are preferable from the viewpoint of reproducibility in film formability and refractive index, stability, and the like.

The low refractive index material is a material having a refractive index relatively lower than that of the medium refractive index layer material, and the refractive index at a wavelength of 500 nm is preferably 1.3 or more and 1.7 or less, more preferably 1.3 or more and 1.65 or less, and further preferably 1.3 or more and 1.6 or less. Examples of the low refractive index material include SiO₂, SiOₓN_{y}, and MgF₂. Other commercially available products thereof include S4F and S5F (mixtures of SiO₂ and AlO₂) manufactured by Canon Optron, Inc. Among them, SiO₂ is preferable from the viewpoint of reproducibility in film formability, stability, economic efficiency, and the like.

The film thickness (physical film thickness) of the dielectric multilayer film A and the dielectric multilayer film B is preferably 100 nm or more, and more preferably 300 nm or more from the viewpoint of preventing deterioration of the material, and is preferably 5 μm or less from the viewpoint of productivity and prevention of a reflection ripple in the visible light region.

The filter may include a dielectric multilayer film C on at least one outermost surface. From the viewpoint of reducing occurrence of ripples in the visible light region, the dielectric multilayer film C is preferably designed as, for example, a near-infrared antireflection layer (NIR antireflection layer).

The total number of laminated layers of the dielectric multilayer film C is preferably 25 or less, more preferably 20 or less, and further preferably 17 or less, and is preferably 10 or more. In order to prevent reflection in a visible wavelength band even when the incident angle is changed, a film having a low reflectance in the entire wavelength band is preferable rather than a film that reflects light of a specific wavelength.

A film thickness (physical film thickness) of the dielectric multilayer film C is preferably 200 μm to 600 μm as a whole.

For formation of the dielectric multilayer film, for example, a vacuum film formation process such as a CVD method, a sputtering method, or a vacuum deposition method, a wet film formation process such as a spraying method or a dipping method, or the like can be used.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high visible light transmittance and have light absorbing properties in a wide range of an infrared wavelength region exceeding 1,200 nm, and thus can be used in the case where light-shielding properties of infrared light are required.

### <Imaging Device>

The imaging device according to the present invention preferably includes the optical filter according to the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the filter which is excellent in transmittance of visible light and specific near-infrared light, has shielding properties of specific near-infrared light, and has a spectral curve hardly shifted even at a high incident angle, it is possible to obtain an imaging device excellent in color reproducibility even for light at a high incident angle.

When the optical filter is mounted on the imaging device, in a case where the dielectric multilayer film A and the dielectric multilayer film B are provided, it is usually preferable that the dielectric multilayer film A be on a sensor side and the dielectric multilayer film B be on a lens side.

As described above, the present description discloses the following optical filter and the like.
[1] An optical filter including:
a light-absorbing material λ_{700L} having a maximum absorption wavelength in a wavelength region longer than 700 nm;
a light-absorbing material Y_{970S} having a maximum absorption wavelength in a wavelength region shorter than 970 nm; and
a dielectric multilayer film, in which
the optical filter satisfies all of the following spectral characteristics (i-1) to (i-4):
(i-1) an average transmittance T_{420-650(0 deg)AVE} is 75% or more in a spectral transmittance curve at a wavelength of 420 nm to 650 nm and an incident angle of 0 degrees, and an average transmittance T_{420-650(35 deg)AVE} is 75% or more in a spectral transmittance curve at a wavelength of 420 nm to 650 nm and an incident angle of 35 degrees,
(i-2) an average transmittance T_{710-950(0 deg)AVE} is 1% or less in a spectral transmittance curve at a wavelength of 710 nm to 950 nm and an incident angle of 0 degrees, and an average transmittance T_{710-950(35 deg)AVE} is 1% or less in a spectral transmittance curve at a wavelength of 710 nm to 950 nm and an incident angle of 35 degrees,
(i-3) a maximum transmittance T_{950-1200(0 deg)MAX} is 60% or more in a spectral transmittance curve at a wavelength of 950 nm to 1,200 nm and an incident angle of 0 degrees, and a maximum transmittance T_{950-1200(35 deg)MAX} is 50% or more in a spectral transmittance curve at a wavelength of 950 nm to 1,200 nm and an incident angle of 35 degrees, and
(i-4) |λ_{IRS(0 deg)(50%)}−λ_{IRS(35 deg)(50%)}|≤15 nm is satisfied, where
λ_{IRS(0 deg)(50%)} is a wavelength at which a transmittance is 50% in a wavelength region shorter than λ_{950-1200(0 deg)MAX} and at an incident angle of 0 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.
[2] The optical filter according to [1], in which
the optical filter further satisfies the following spectral characteristic (i-5):
(i-5) 10/[λ_{IRS(0 deg)(45%)}−λ_{IRS(0 deg)(55%)}]|≥1.0 Is satisfied, where
λ_{IRS(0 deg)(55%)} is a wavelength at which a transmittance is 55% in the wavelength region shorter than λ_{950-1200(0 deg)MAX} and at an incident angle of 0 degrees,
λ_{IRS(0 deg)(45%)} is a wavelength at which a transmittance is 45% in the wavelength region shorter than λ_{950-1200(0 deg)MAX} and at an incident angle of 0 degrees, and λ_{950-1200(0 deg)MAX} is a wavelength at which a maximum transmittance is obtained in the spectral transmittance curve at a wavelength of 950 nm to 1,200 nm and an incident angle of 0 degrees.
[3] The optical filter according to [1] or [2], in which the optical filter further satisfies the following spectral characteristics (i-6) to (i-8):
(i-6) 10 nm≤|λ_{IRL(0 deg)(50%)}−λ_{IRS(0 deg)(50%)}|≤100 nm is satisfied, where
λ_{IRL(0 deg)(50%)} is a wavelength at which a transmittance is 50% in a wavelength region longer than λ_{950-1200(0 deg)MAX} and at an incident angle of 0 degrees,
λ_{IRS(0 deg)(50%)} is a wavelength at which a transmittance is 50% in the wavelength region shorter than λ_{950-1200(0 deg)MAX} and at an incident angle of 0 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-7) 20 nm≤|λ_{IRL(35 deg)(50%)}−λ_{IRS(35 deg)(50%)}|≤100 nm is satisfied, where
λ_{IRL(35 deg)(50%)} is a wavelength at which a transmittance is 50% in the wavelength region longer than λ_{950-1200(0 deg)MAX} and at an incident angle of 35 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-8) λ_{IRL(0 deg)(50%)}, λ_{IRS(0 deg)(50%)}, λ_{IRL(35 deg)(50%)}, and λ_{IRS(35 deg)(50%)} satisfy the following relational expression:

$$\vert [ {λ}_{I R L ( 35 deg ) ( 50 \% )} - {λ}_{I R S ( 35 deg ) ( 50 \% )} ] - [ {λ}_{I R L ( 0 deg ) ( 50 \% )} - {λ}_{I R S ( 0 deg ) ( 50 \% )} ] \vert \leq 70 nm .$$

[4] The optical filter according to any of [1] to [3], in which
the optical filter further satisfies the following spectral characteristics (i-9) and (i-10):
(i-9) 10 (%·nm)≤IRP-A_{(0deg)}≤100 (%·nm) is satisfied, where IRP-A_{(0deg)} is an integral value of a transmittance in a wavelength band in which the transmittance is 20% or more in the spectral transmittance curve at a wavelength of 950 nm to 1,200 nm and an incident angle of 0 degrees, and
(i-10) 10 (%·nm)≤IRP-A_{(35deg)}≤100 (%·nm) is satisfied, where IRP-A_{(35deg)} is an integral value of a transmittance in a wavelength band in which the transmittance is 20% or more in a spectral transmittance curve at a wavelength of 950 nm to 1,200 nm and an incident angle of 35 degrees.
[5] The optical filter according to [4], in which
IRP-A_{(0deg)}_and IRP-A_{(35deg)} satisfy the following relational expression:

$$0.5 \leq IRP - {A}_{( 35 deg )} / IRP - {A}_{( 0 deg )} \leq 1.1 .$$

[6] The optical filter according to any of [1] to [5], in which
the optical filter further satisfies the following spectral characteristic (i-11):
(i-11) 0.5≤[IRP-A_{(35deg)}/VIS-A_{(35deg)}]/[IRP-A_{(0deg)}/VIS-A_{(0deg)}]≤1.1 is satisfied, where
VIS-A_{(0deg)} is an integral value of a transmittance in a wavelength band in which the transmittance is 20% or more in the spectral transmittance curve at a wavelength of 420 nm to 650 nm and an incident angle of 0 degrees,
VIS-A_{(35deg)} is an integral value of a transmittance in a wavelength band in which the transmittance is 20% or more in a spectral transmittance curve at a wavelength of 420 nm to 650 nm and an incident angle of 35 degrees,
IRP-A_{(0deg)} is an integral value of a transmittance in a wavelength band in which the transmittance is 20% or more in the spectral transmittance curve at a wavelength of 950 nm to 1,200 nm and an incident angle of 0 degrees, and
IRP-A_{(35deg)} is an integral value of a transmittance in a wavelength band in which the transmittance is 20% or more in a spectral transmittance curve at a wavelength of 950 nm to 1,200 nm and an incident angle of 35 degrees.
[7] The optical filter according to any of [1] to [6], in which
the optical filter further satisfies the following spectral characteristic (i-12):
(i-12) |λ_{IRR(5 deg)(50%)}−λ_{IRS(0 deg)(50%)}|≥20 nm is satisfied, where
λ_{IRS(0 deg)(50%)} is a wavelength at which a transmittance is 50% in the wavelength region shorter than λ_{950-1200(0 deg)MAX} and at an incident angle of 0 degrees,
λ_{IRR(5 deg)(50%)} is a wavelength at which a reflectance is 50% in a wavelength region longer than 950 nm and at an incident angle of 5 degrees in a spectral reflectance curve at a wavelength of 950 nm to 1,200 nm and an incident angle of 5 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.
[8] The optical filter according to any of [1] to [7], in which
the light-absorbing material Y_{970S} satisfies the following spectral characteristics (iii-1) and (iii-2):
(iii-1) maximum optical density at wavelength of 900 nm to 1,000 nm>0.6, and
(iii-2) a wavelength at which a transmittance is 50% on a side of a wavelength longer than the maximum optical density at a wavelength of 900 nm to 1,000 nm is in a range of 950 nm to 1,050 nm.
[9] The optical filter according to any of [1] to [8], in which
the light-absorbing material Y_{970S} is an inorganic material containing ytterbium.
[10] The optical filter according to any of [1] to [9], in which
the light-absorbing material Y_{970S} is a glass containing ytterbium.
[11] The optical filter according to any of [1] to [10], in which
the optical filter includes a light-absorbing layer containing the light-absorbing material λ_{700L}, and
the optical filter satisfies both the following spectral characteristics (ii-1) and (ii-2),
when a light is incident from a dielectric multilayer film side, an absorption loss amount_{X} at a wavelength of X nm is defined as follows,

$${( absorption loss amount )}_{X} [ \% ] = 100 - ( transmittance at incident angle of 0 degrees ) - ( reflectance at incident angle of 5 degrees ) ,$$

(ii-1) a maximum value of an absorption loss amount₆₀₀₋₈₃₀ at a wavelength of 600 nm to 830 nm is 85 or more, and
(ii-2) an integral value of the absorption loss amount₆₀₀₋₈₃₀ at a wavelength of 600 nm to 830 nm is 5,000 or more.
[12] The optical filter according to any of [1] to [11], in which
the optical filter further includes:
a substrate including the light-absorbing material Y_{970S},
a dielectric multilayer film A provided on or above one main surface of the substrate, and
a light-absorbing layer provided on or above the one main surface of the substrate,
the light-absorbing layer including the light-absorbing material λ_{700L}, and
the dielectric multilayer film A satisfies the following characteristics (iv-1), (iv-2), and (iv-3):
(iv-1) the dielectric multilayer film A comprises three or more laminated structures, each of the laminated structures includes a high refractive index layer H_{A} including a high refractive index material having a refractive index of 1.9 or more and 3.0 or less at a wavelength of 500 nm and a medium refractive index layer M_{A} including a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{A}/medium refractive index layer M_{A}), and
(here, in a case where the medium refractive index layer M_{A} includes the high refractive index layer H_{A} and a low refractive index layer L_{A} including a low refractive index material having a refractive index of 1.3 or more and 1.7 or less at a wavelength of 500 nm, the medium refractive index layer M_{A} is treated as an equivalent film),
(iv-2) the dielectric multilayer film A includes a laminated structure represented by (aₙQH_{A}/bₙQM_{A})
where QH_{A} is a QWOT of the high refractive index layer H_{A} at a wavelength of 500 nm and QM_{A} is a QWOT of the medium refractive index layer M_{A} at a wavelength of 500 nm, and
an average value of aₙ is 1.2 or more and 2.7 or less and an average value of bₙ is 1.1 or more and 2.2 or less, and
(iv-3) the number of laminated layers is in a range of 1 to 60.
[13] The optical filter according to any of [1] to [12], in which
the optical filter further includes:
a substrate including the light-absorbing material Y_{970S},
a dielectric multilayer film A provided on or above one main surface of the substrate,
a dielectric multilayer film B provided on or above the other main surface of the substrate, and
a light-absorbing layer provided on or above the one main surface of the substrate,
the light-absorbing layer including the light-absorbing material λ_{700L}, and
the dielectric multilayer film B satisfies the following characteristics (v-1), (v-2), and (v-3):
(v-1) the dielectric multilayer film B includes three or more laminated structures, each of the laminated structures includes a high refractive index layer H_{B} including a high refractive index material having a refractive index of 1.9 or more and 3.0 or less at a wavelength of 500 nm and a medium refractive index layer M_{B} including a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{B}/medium refractive index layer M_{B}), and
the medium refractive index layer M_{B} is treated as an equivalent film in a case where the medium refractive index layer M_{B} includes the high refractive index layer H_{B} and a low refractive index layer L_{B} including a low refractive index material having a refractive index of 1.3 or more and 1.7 or less at a wavelength of 500 nm, (v-2) the dielectric multilayer film B includes a laminated structure represented by (cₙQH_{B}/dₙQM_{B})
where QH_{B} is a QWOT of the high refractive index layer H_{B} at a wavelength of 500 nm and QM_{B} is a QWOT of the medium refractive index layer M_{B} at a wavelength of 500 nm, and
here, an average value of cₙ is 1.9 or more and 5.0 or less, and an average value of dₙ is 1.2 or more and 2.9 or less, and
(iv-3) the number of laminated layers is in a range of 1 to 60.
[14] An imaging device including the optical filter according to any of [1] to [13].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of an optical filter).

Dyes used in respective examples are as follows.
Compound 1 (squarylium compound): synthesized based on U.S. Pat. No. 5,543,086.
Compound 2 (merocyanine compound): synthesized based on the description of German Patent No. 10109243.
Compound 3 (cyanine compound): synthesized based on Dyes and pigments 73 (2007) 344-352.

The compounds 1 and 3 are near-infrared ray absorbing dyes (NIR dyes), and the compound 2 is a near ultraviolet absorbing dye (UV dye).

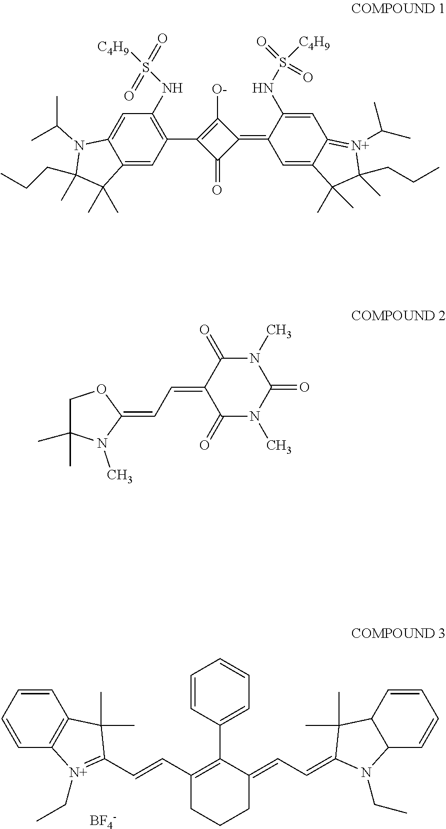

### <Spectral Characteristics of Dye>

Maximum absorption wavelengths in absorption spectrums measured after dissolving the above-mentioned dyes (compounds 1 to 3) in dichloromethane are shown in Table 2 below.

### <Spectral Characteristics of Light-Absorbing Glass (Light-Absorbing Material Y_{970S})>

A glass A manufactured by the following manufacturing method was used as the light-absorbing material Y_{970S}.

Raw materials including, in terms of mol % based on an oxide, 7.5% of SiO₂, 23.6% of B₂O₃, 7.5% of P₂O₅, 47.2% of Yb₂O₃, 11.8% of Ga₂O₃, and 2.4% of La₂O₃ were weighed and mixed, placed in a crucible having an internal volume of about 400 cc, and melted at 1,400° C. to 1,650° C. for 2 hours in an air atmosphere. Thereafter, the mixture was refined, stirred, and cast into a rectangular mold of 100 mm length×50 mm width×20 mm height that was preheated to about 300° C. to 500° C., slowly cooled to room temperature at about −1° C./min, and cut into a predetermined thickness within a range of 40 mm length×30 mm width×0.3 mm to 1.5 mm thickness, and both surfaces of the resultant were optically polished to obtain a plate-shaped glass A.

The following materials were used as the raw materials for the glass.
SiO₂: oxide
B₂O₃: one or more selected from oxide, PBO₄, and H₃BO₃
P₂O₅: one or more of H₃PO₄ and PBO₄
GeO₂: oxide
ZrO₂: oxide
Ga₂O₃: oxide
Yb₂O₃: oxide
La₂O₃: oxide
Al₂O₃: one or more of oxide and Al(OH)₃

The raw materials of the glass are not limited to the above, and known raw materials can be used.

### [Evaluation]

For the glass plate produced as described above, a spectral transmittance curve and a spectral reflectance curve in a wavelength range of 350 nm to 1,200 nm were measured using a spectrophotometer (V-570, manufactured by JASCO Corporation), and the optical density was calculated based on the obtained transmittance.

Results are shown in Table 1 below. The spectral characteristics shown in the following table were evaluated in terms of internal transmittance in order to avoid an influence of reflection at an air interface and a glass interface.

$$Internal transmittance ( \% ) = \{ measured {transmittance}_{( 0 deg )} / ( 100 - {reflectance}_{( 5 deg )} ) \} \times 100$$

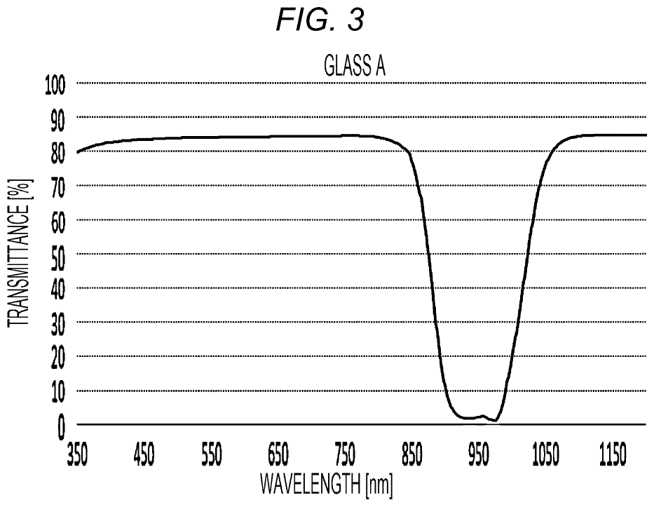

The spectral transmission curve of the glass A is illustrated in FIG. 3.

TABLE 1

| | | Near-infrared ray |
|---|---|---|
| | | absorbing glass |
| Light-absorbing | Glass material type | Glass A |
| material Y970s | Thickness [mm] | 0.56 |
| Spectral | Maximum optical density at wavelength of 900 nm to 1,000 nm | 0.75 |
| characteristics | Wavelength at which transmittance is 50% on side of wavelength | 999 |
| | longer than wavelength at which optical density is maximum at | |
| | wavelength of 900 nm to 1,000 nm [nm] | |
| | Maximum absorption wavelength (nm) | 975 |

### Example 1-1: Spectral Characteristics of Light-absorbing Layer

The dyes of the compounds 1 to 4 were dissolved in a polyimide resin C-3G30G manufactured by Mitsubishi Gas Chemical Company, Inc., mixed at a concentration shown in the following table, and stirred and dissolved at 50° C. for 2 hours to obtain a coating solution. The obtained coating solution was applied onto an alkali glass (D263 glass, thickness: 0.2 mm, manufactured by SCHOTT) by a spin coating method to form a light-absorbing layer having a film thickness shown in the following table.

With respect to the obtained light-absorbing layer, a spectral transmittance curve and a spectral reflectance curve in a wavelength range of 350 nm to 1,200 nm were measured using the ultraviolet-visible spectrophotometer.

Results are shown in Table 2 below.

The spectral characteristics shown in the following table were evaluated in terms of internal transmittance in order to avoid an influence of reflection at an air interface and a glass interface.

$$Internal transmittance ( \% ) = \{ measured {transmittance}_{( 0 deg )} / ( 100 - {reflectance}_{( 5 deg )} ) \} \times 100$$

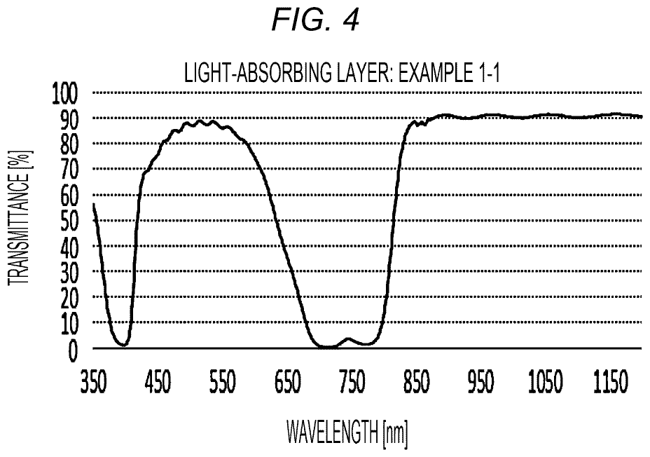

A spectral transmittance curve of the light-absorbing layer of Example 1-1 is illustrated in FIG. 4.

Example 1-1 is a reference example.

TABLE 2

| Light-absorbing layer | | Example 1-1 |
|---|---|---|
| Added amount of dye (mass %) | Compound 1 (λMAX: 772 nm) | 5.6 |
| | Compound 2 (λMAX: 397 nm) | 4.9 |
| | Compound 3 (λMAX: 713 nm) | 4.1 |
| | Total | 14.6 |
| Film thickness of absorption layer (μm) | | 1.4 |
| Spectral characteristics | Maximum absorption wavelength (nm) | 713.0 |

### Example 2-1: Spectral Characteristics of Optical Filter

A dielectric multilayer film A1 (reflective film) was formed by alternately laminating SiO₂ and TiO₂ on one main surface of the glass substrate (light-absorbing glass A) by vapor deposition.

A dielectric multilayer film B1 (reflective film) was formed by alternately laminating SiO₂ and TiO₂ on the other main surface of the glass substrate (light-absorbing glass A) by vapor deposition.

A resin solution was applied to a surface of the dielectric multilayer film A1 with the same composition as that of the light-absorbing layer of Example 1-1, and an organic solvent was removed by sufficiently heating to form a light-absorbing layer having a thickness of 1.4 μm.

A dielectric multilayer film C1 (antireflection film) was formed by alternately laminating SiO₂ and TiO₂ on a surface of the light-absorbing layer by vapor deposition.

Thus, an optical filter 2-1 was manufactured.

### Example 2-2

An optical filter 2-2 was manufactured in the same manner as in Example 2-1 except that a dielectric multilayer film A2 (reflective film) was formed instead of the dielectric multilayer film A1 (reflective film), and a dielectric multilayer film B2 (reflective film) was formed instead of the dielectric multilayer film B1 (reflective film).

### Example 2-3

An optical filter 2-3 was manufactured in the same manner as in Example 2-1 except that a dielectric multilayer film B3 (antireflection film) was formed instead of the dielectric multilayer film B1 (reflective film).

### Example 2-4

An optical filter 2-4 was manufactured in the same manner as in Example 2-1 except that a glass B (D263 glass manufactured by SCHOTT, borosilicate glass, thickness: 0.30 mm) having no light absorbing property was used instead of the light-absorbing glass A.

### Example 2-5

An optical filter 2-5 was manufactured in the same manner as in Example 2-1 except that a glass B (D263 glass manufactured by SCHOTT, borosilicate glass, thickness: 0.56 mm) having no light absorbing property was used instead of the light-absorbing glass A.

Configurations of the dielectric multilayer films A1 and A2, the dielectric multilayer films B1 to B3, and the dielectric multilayer film C1 are shown in Tables 3 to 8 below. An order of the numbers (No.) corresponds to a lamination order.

In the dielectric multilayer film A1, the average value of aₙ is 1.74, and the average value of bₙ is 1.72.

In the dielectric multilayer film A2, the average value of aₙ is 1.73, and the average value of b₁ is 1.73.

In the dielectric multilayer film B1, the average value of cₙ is 3.46, and the average value of dₙ is 1.65.

In the dielectric multilayer film B2, the average value of cₙ is 3.29, and the average value of dₙ is 1.95.

TABLE 3
Dielectric multilayer film A1

| | Film | Film | Physical film | | |
|---|---|---|---|---|---|
| No. | arrangement | material | thickness [nm] | Coefficient | |
| 53 | — | TiO₂ | 13.3 | — | — |
| 52 | — | SiO₂ | 40.6 | — | — |
| 51 | — | TiO₂ | 124.5 | — | — |
| 50 | — | SiO₂ | 20.5 | — | — |
| 49 | — | TiO₂ | 125.2 | — | — |
| 48 | M | SiO₂ | 58.0 | bn | 1.556 |
| 47 | | TiO₂ | 19.7 | | |
| 46 | | SiO₂ | 40.4 | | |
| 45 | H | TiO₂ | 68.6 | an | 1.353 |
| 44 | M | SiO₂ | 27.6 | bn | 2.128 |
| 43 | | TiO₂ | 9.2 | | |
| 42 | | SiO₂ | 136.5 | | |
| 41 | H | TiO₂ | 107.9 | an | 2.129 |
| 40 | M | SiO₂ | 40.5 | bn | 1.202 |
| 39 | | TiO₂ | 19.0 | | |
| 38 | | SiO₂ | 29.3 | | |
| 37 | H | TiO₂ | 103.6 | an | 2.045 |
| 36 | M | SiO₂ | 56.0 | bn | 1.542 |
| 35 | | TiO₂ | 13.0 | | |
| 34 | | SiO₂ | 52.4 | | |
| 33 | H | TiO₂ | 93.6 | an | 1.847 |
| 32 | — | SiO₂ | 162.5 | — | — |
| 31 | — | TiO₂ | 64.0 | — | — |
| 30 | M | SiO₂ | 13.1 | bn | 2.217 |
| 29 | | TiO₂ | 15.9 | | |
| 28 | | SiO₂ | 126.3 | | |
| 27 | | TiO₂ | 9.8 | | |
| 26 | | SiO₂ | 4.8 | | |
| 25 | H | TiO₂ | 77.5 | an | 1.529 |
| 24 | — | SiO₂ | 145.4 | — | — |
| 23 | — | TiO₂ | 84.9 | — | — |
| 22 | — | SiO₂ | 144.8 | — | — |
| 21 | — | TiO₂ | 86.2 | — | — |
| 20 | M | SiO₂ | 76.2 | bn | 1.693 |
| 19 | | TiO₂ | 4.0 | | |
| 18 | | SiO₂ | 59.8 | | |
| 17 | H | TiO₂ | 81.6 | an | 1.610 |
| 16 | M | SiO₂ | 17.9 | bn | 1.899 |
| 15 | | TiO₂ | 8.4 | | |
| 14 | | SiO₂ | 91.4 | | |
| 13 | | TiO₂ | 12.7 | | |
| 12 | | SiO₂ | 15.7 | | |
| 11 | H | TiO₂ | 83.0 | an | 1.637 |
| 10 | M | SiO₂ | 61.9 | bn | 1.549 |
| 9 | | TiO₂ | 14.4 | | |
| 8 | | SiO₂ | 44.6 | | |
| 7 | H | TiO₂ | 92.2 | an | 1.820 |
| 6 | — | SiO₂ | 17.6 | — | — |
| 5 | — | TiO₂ | 29.5 | — | — |
| 4 | — | SiO₂ | 22.1 | — | — |
| 3 | — | TiO₂ | 103.8 | — | — |
| 2 | — | SiO₂ | 13.8 | — | — |
| 1 | — | TiO₂ | 14.8 | — | — |

TABLE 4
Dielectric multilayer film A2

| | Film | Film | Physical film | | |
|---|---|---|---|---|---|
| No. | arrangement | material | thickness [nm] | Coefficient | |
| 53 | — | TiO₂ | 12.7 | — | — |
| 52 | — | SiO₂ | 38.8 | — | — |
| 51 | — | TiO₂ | 121.8 | — | — |
| 50 | — | SiO₂ | 20.2 | — | — |
| 49 | — | TiO₂ | 123.6 | — | — |
| 48 | M | SiO₂ | 65.5 | bn | 1.628 |
| 47 | | TiO₂ | 17.2 | | |
| 46 | | SiO₂ | 43.2 | | |
| 45 | H | TiO₂ | 66.1 | an | 1.304 |
| 44 | M | SiO₂ | 29.3 | bn | 2.115 |
| 43 | | TiO₂ | 8.6 | | |
| 42 | | SiO₂ | 134.6 | | |
| 41 | H | TiO₂ | 109.5 | an | 2.162 |
| 40 | M | SiO₂ | 37.5 | bn | 1.169 |
| 39 | | TiO₂ | 20.1 | | |
| 38 | | SiO₂ | 27.6 | | |
| 37 | H | TiO₂ | 105.1 | an | 2.075 |
| 36 | M | SiO₂ | 57.5 | bn | 1.564 |
| 35 | | TiO₂ | 13.3 | | |
| 34 | | SiO₂ | 52.3 | | |
| 33 | H | TiO₂ | 93.4 | an | 1.844 |
| 32 | — | SiO₂ | 162.3 | — | — |
| 31 | — | TiO₂ | 63.8 | — | — |
| 30 | M | SiO₂ | 13.5 | bn | 2.223 |
| 29 | | TiO₂ | 15.9 | | |
| 28 | | SiO₂ | 125.7 | | |
| 27 | | TiO₂ | 10.3 | | |
| 26 | | SiO₂ | 4.6 | | |
| 25 | H | TiO₂ | 76.6 | an | 1.511 |
| 24 | — | SiO₂ | 146.0 | — | — |
| 23 | — | TiO₂ | 85.6 | — | — |
| 22 | — | SiO₂ | 144.9 | — | — |
| 21 | — | TiO₂ | 86.1 | — | — |
| 20 | M | SiO₂ | 76.2 | bn | 1.705 |
| 19 | | TiO₂ | 4.0 | | |
| 18 | | SiO₂ | 60.9 | | |
| 17 | H | TiO₂ | 81.7 | an | 1.612 |
| 16 | M | SiO₂ | 16.9 | bn | 1.868 |
| 15 | | TiO₂ | 7.1 | | |
| 14 | | SiO₂ | 96.0 | | |
| 13 | | TiO₂ | 11.2 | | |
| 12 | | SiO₂ | 14.1 | | |
| 11 | H | TiO₂ | 82.7 | an | 1.632 |
| 10 | M | SiO₂ | 68.4 | bn | 1.594 |
| 9 | | TiO₂ | 12.5 | | |
| 8 | | SiO₂ | 45.2 | | |
| 7 | H | TiO₂ | 87.8 | an | 1.732 |
| 6 | — | SiO₂ | 19.4 | — | — |
| 5 | — | TiO₂ | 29.0 | — | — |
| 4 | — | SiO₂ | 24.7 | — | — |
| 3 | — | TiO₂ | 101.3 | — | — |
| 2 | — | SiO₂ | 13.1 | — | — |
| 1 | — | TiO₂ | 13.4 | — | — |

TABLE 5
Dielectric multilayer film B1

| | Film | Film | Physical film | | |
|---|---|---|---|---|---|
| No. | arrangement | material | thickness [nm] | Coefficient | |
| 1 | — | TiO₂ | 19.3 | — | — |
| 2 | — | SiO₂ | 20.4 | — | — |
| 3 | H | TiO₂ | 141.3 | cn | 2.789 |
| 4 | M | SiO₂ | 20.2 | dn | 1.248 |
| 5 | | TiO₂ | 40.3 | | |
| 6 | | SiO₂ | 18.0 | | |
| 7 | H | TiO₂ | 248.4 | cn | 4.903 |
| 8 | M | SiO₂ | 25.1 | dn | 1.368 |
| 9 | | TiO₂ | 32.9 | | |
| 10 | | SiO₂ | 35.4 | | |
| 11 | H | TiO₂ | 133.4 | cn | 2.632 |
| 12 | M | SiO₂ | 46.3 | dn | 1.541 |
| 13 | | TiO₂ | 25.5 | | |
| 14 | | SiO₂ | 41.2 | | |
| 15 | H | TiO₂ | 152.5 | cn | 3.011 |
| 16 | M | SiO₂ | 12.0 | dn | 2.891 |
| 17 | | TiO₂ | 62.3 | | |
| 18 | | SiO₂ | 30.5 | | |
| 19 | | TiO₂ | 34.6 | | |
| 20 | | SiO₂ | 40.0 | | |
| 21 | — | TiO₂ | 124.4 | — | — |
| 22 | — | SiO₂ | 188.8 | — | — |
| 23 | H | TiO₂ | 123.8 | cn | 2.443 |
| 24 | M | SiO₂ | 39.0 | dn | 1.415 |
| 25 | | TiO₂ | 31.2 | | |
| 26 | | SiO₂ | 28.3 | | |
| 27 | H | TiO₂ | 253.3 | cn | 4.999 |
| 28 | M | SiO₂ | 27.4 | dn | 1.407 |
| 29 | | TiO₂ | 31.8 | | |
| 30 | | SiO₂ | 38.3 | | |
| 31 | — | TiO₂ | 122.3 | — | — |
| 32 | — | SiO₂ | 188.1 | — | — |
| 33 | — | TiO₂ | 120.7 | — | — |
| 34 | — | SiO₂ | 45.4 | — | — |
| 35 | — | TiO₂ | 22.7 | — | — |
| 36 | — | SiO₂ | 73.1 | — | — |
| 37 | — | TiO₂ | 12.4 | — | — |
| 38 | — | SiO₂ | 107.3 | — | — |
| 39 | — | TiO₂ | 12.6 | — | — |
| 40 | — | SiO₂ | 39.9 | — | — |
| 41 | — | TiO₂ | 100.5 | — | — |
| 42 | — | SiO₂ | 85.7 | — | — |

TABLE 6
Dielectric multilayer film B2

| | Film | Film | Physical film | | |
|---|---|---|---|---|---|
| No. | arrangement | material | thickness [nm] | Coefficient | |
| 1 | — | TiO₂ | 20.5 | — | — |
| 2 | — | SiO₂ | 24.5 | — | — |
| 3 | H | TiO₂ | 131.4 | cn | 2.594 |
| 4 | M | SiO₂ | 57.9 | dn | 1.625 |
| 5 | | TiO₂ | 18.5 | | |
| 6 | | SiO₂ | 48.3 | | |
| 7 | H | TiO₂ | 232.8 | cn | 4.594 |
| 8 | M | SiO₂ | 50.1 | dn | 1.874 |
| 9 | | TiO₂ | 11.8 | | |
| 10 | | SiO₂ | 88.3 | | |
| 11 | H | TiO₂ | 111.2 | cn | 2.196 |
| 12 | M | SiO₂ | 96.5 | dn | 1.914 |
| 13 | | TiO₂ | 11.7 | | |
| 14 | | SiO₂ | 45.4 | | |
| 15 | H | TiO₂ | 172.4 | cn | 3.403 |
| 16 | M | SiO₂ | 11.8 | dn | 2.725 |
| 17 | | TiO₂ | 53.3 | | |
| 18 | | SiO₂ | 34.7 | | |
| 19 | | TiO₂ | 34.4 | | |
| 20 | | SiO₂ | 37.2 | | |
| 21 | — | TiO₂ | 132.2 | — | — |
| 22 | — | SiO₂ | 191.5 | — | — |
| 23 | H | TiO₂ | 118.5 | cn | 2.339 |
| 24 | M | SiO₂ | 66.4 | dn | 1.718 |
| 25 | | TiO₂ | 17.9 | | |
| 26 | | SiO₂ | 48.6 | | |
| 27 | H | TiO₂ | 233.3 | cn | 4.605 |
| 28 | M | SiO₂ | 53.2 | dn | 1.812 |
| 29 | | TiO₂ | 13.9 | | |
| 30 | | SiO₂ | 76.4 | | |
| 31 | — | TiO₂ | 116.4 | — | — |
| 32 | — | SiO₂ | 189.5 | — | — |
| 33 | — | TiO₂ | 130.2 | — | — |
| 34 | — | SiO₂ | 35.2 | — | — |
| 35 | — | TiO₂ | 27.2 | — | — |
| 36 | — | SiO₂ | 70.6 | — | — |
| 37 | — | TiO₂ | 11.7 | — | — |
| 38 | — | SiO₂ | 86.9 | — | — |
| 39 | — | TiO₂ | 14.8 | — | — |
| 40 | — | SiO₂ | 32.4 | — | — |
| 41 | — | TiO₂ | 108.6 | — | — |
| 42 | — | SiO₂ | 90.3 | — | — |

TABLE 7
Dielectric multilayer film B3

| | | Physical |
|---|---|---|
| | Film | thickness |
| No. | material | [nm] |
| 8 | SiO₂ | 105.2 |
| 7 | TiO₂ | 29.1 |
| 6 | SiO₂ | 13.4 |
| 5 | TiO₂ | 77.8 |
| 4 | SiO₂ | 25.9 |
| 3 | TiO₂ | 24.2 |
| 2 | SiO₂ | 63.5 |
| 1 | TiO₂ | 9.1 |

TABLE 8
Dielectric multilayer film C1

| | Film | Physical film |
|---|---|---|
| No. | material | thickness [nm] |
| 8 | SiO₂ | 105.2 |
| 7 | TiO₂ | 29.1 |
| 6 | SiO₂ | 13.4 |
| 5 | TiO₂ | 77.8 |
| 4 | SiO₂ | 25.9 |
| 3 | TiO₂ | 24.2 |
| 2 | SiO₂ | 63.5 |
| 1 | TiO₂ | 9.1 |

With respect to the respective optical filters obtained as described above, spectral transmittance curves at an incident angle of 0 degrees and an incident angle of 35 degrees, and spectral reflectance curves at an incident angle of 5 degrees and an incident angle of 35 degrees in a wavelength range of 350 nm to 1,200 nm were measured using the ultraviolet-visible spectrophotometer.

Respective characteristics shown in Table 9 below were calculated based on the obtained data of the spectral characteristics.

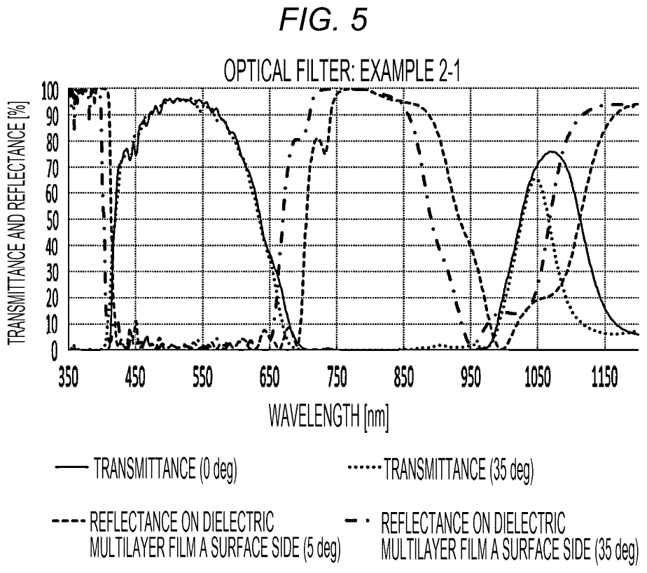

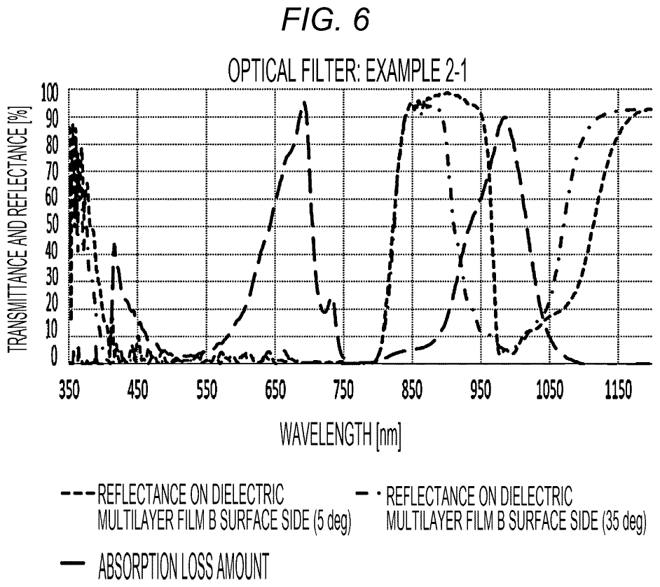

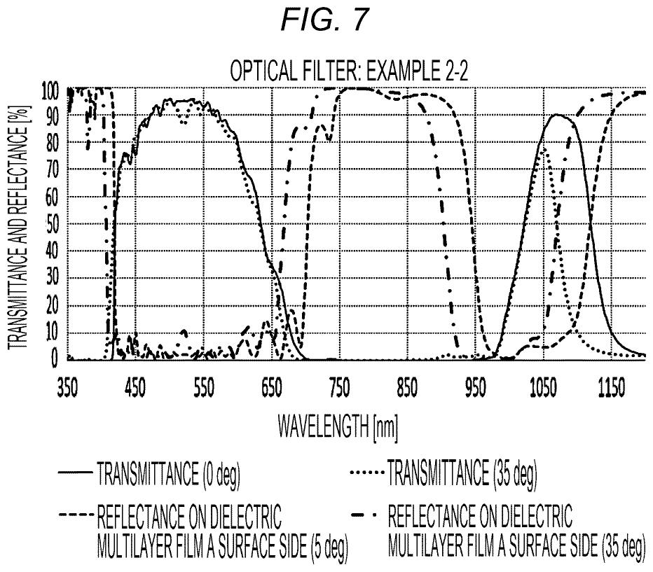

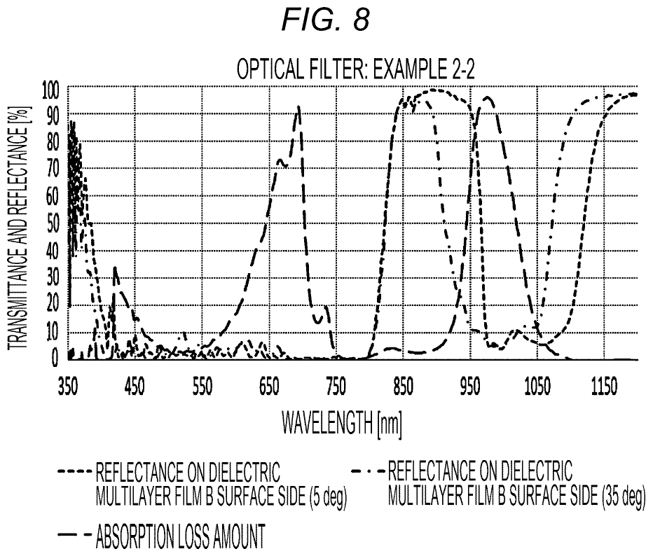

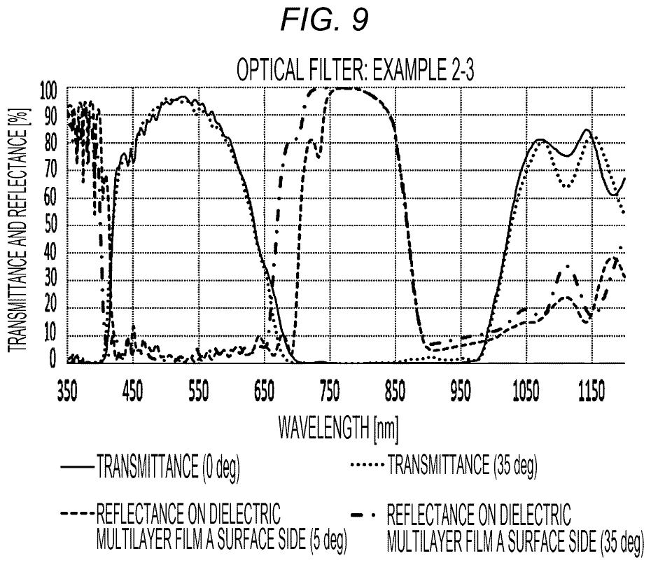

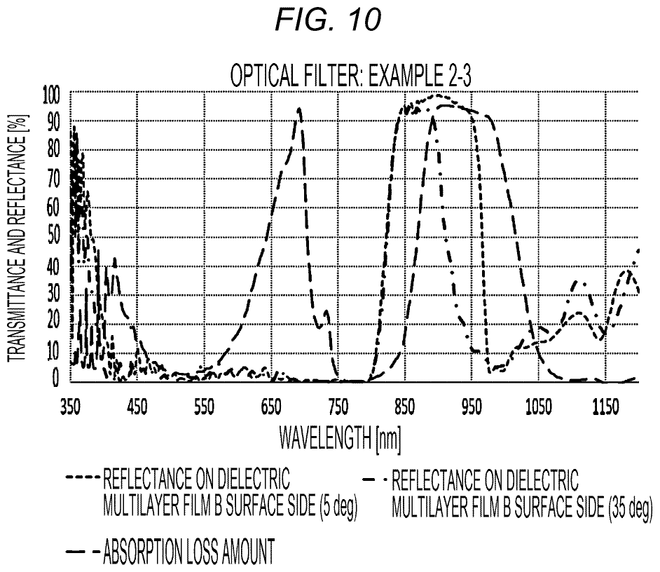

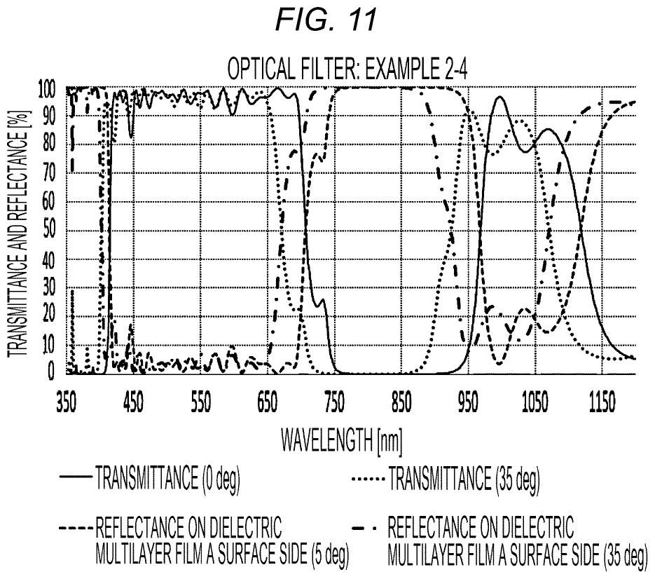

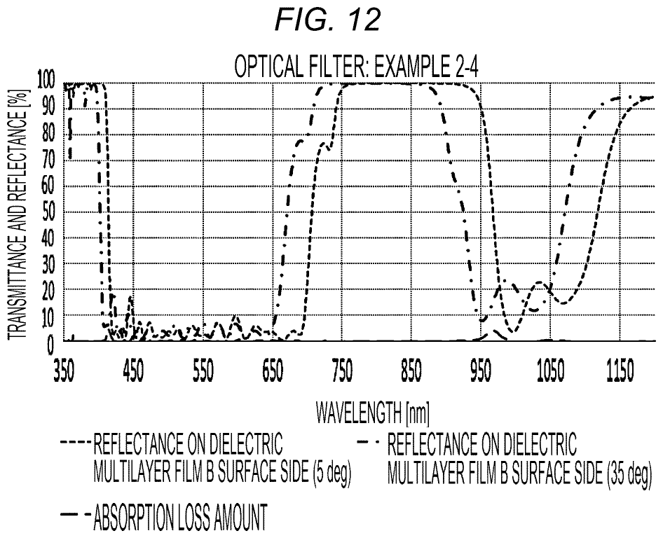

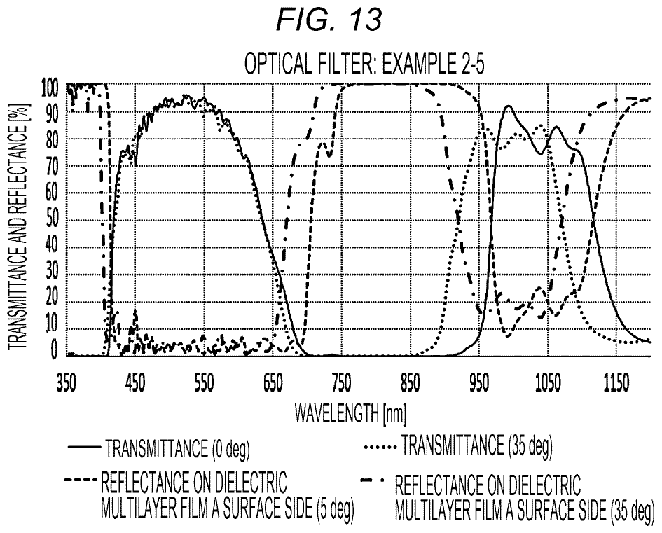

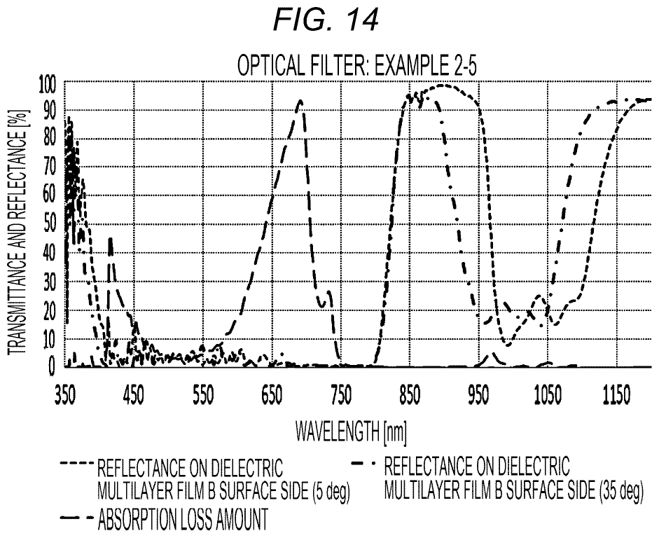

FIGS. 5 to 14 illustrate the spectral transmittance curves, the spectral reflectance curves, and the absorption loss amounts of the optical filters of Examples 2-1 to 2-5.

Examples 2-1 to 2-3 are inventive examples, and Examples 2-4 and 2-5 are comparative examples.

TABLE 9

| | | Example 2-1 | Example 2-2 | Example 2-3 | Example 2-4 | Example 2-5 |
|---|---|---|---|---|---|---|
| Dielectric | Type | Film C1 | Film C1 | Film C1 | Film C1 | Film C1 |
| multilayer film C | Number of film layers | 8 | 8 | 8 | 8 | 8 |
| | Film material | SiO₂/TiO₂ | SiO₂/TiO₂ | SiO₂/TiO₂ | SiO₂/TiO₂ | SiO₂/TiO₂ |
| Light-absorbing layer | | Example 1-1 | Example 1-1 | Example 1-1 | Example 1-1 | Example 1-1 |
| Dielectric | Type | Film A1 | Film A2 | Film A1 | Film A1 | Film A1 |
| multilayer film A | Number of film layers | 53 | 53 | 53 | 53 | 53 |
| | Film material | SiO₂/TiO₂ | SiO₂/TiO₂ | SiO₂/TiO₂ | SiO₂/TiO₂ | SiO₂/TiO₂ |
| Glass substrate | Is light absorbed | Light is | Light is | Light is | Light is not | Light is not |
| | | absorbed | absorbed | absorbed | absorbed | absorbed |
| | Type of glass | Glass A | Glass A | Glass A | Glass B | Glass B |
| | Thickness | 0.56 mm | 0.56 mm | 0.56 mm | 0.30 mm | 0.56 mm |
| Dielectric | Type | Film B1 | Film B2 | Film B3 | Film B1 | Film B1 |
| multilayer film B | Number of film layers | 42 | 42 | 8 | 42 | 42 |
| | Film material | SiO₂/TiO₂ | SiO₂/TiO₂ | SiO₂/TiO₂ | SiO₂/TiO₂ | SiO₂/TiO₂ |
| Spectral | Average transmittance at 420 nm to 650 | 81.9 | 81.1 | 80.7 | 95.9 | 80.7 |
| characteristics | nm and 0 deg [%] | | | | | |
| | Average transmittance at 420 nm to 650 | 81.3 | 79.4 | 80.0 | 96.0 | 79.9 |
| | nm and 35 deg [%] | | | | | |
| | Average transmittance at 710 nm to 950 | 0.1 | 0.0 | 0.1 | 4.1 | 0.6 |
| | nm and 0 deg [%] | | | | | |
| | Average transmittance at 710 nm to 950 | 0.5 | 0.4 | 0.6 | 13.1 | 12.6 |
| | nm and 35 deg [%] | | | | | |
| | Maximum transmittance at 950 nm to | 76.0 | 90.2 | 84.7 | 96.6 | 92.0 |
| | 1,200 nm and 0 deg [%] | | | | | |
| | Maximum transmittance at 950 nm to | 65.4 | 77.4 | 82.2 | 92.1 | 84.8 |
| | 1,200 nm and 35 deg [%] | | | | | |
| | \|λ_{IRS(0deg)50%} − λ_{IRS(35deg)50%}\| [nm] | 2.0 | 1.2 | 2.6 | 0.0 | 0.0 |
| | \|10/[λ_{IRS(0deg)45%} − λ_{IRS(0deg)55%}]\| [nm] | 1.2 | 1.5 | 1.4 | 77.3 | 74.3 |
| | \|λ_{RL(0deg)50%} − λ_{IRS(0deg)50%}\| [nm] | 88.9 | 98.0 | Cannot be | 1,118.1 | Cannot be |
| | | | | calculated | | calculated |
| | \|λ_{RL(35deg)50%} − λ_{IRS(35deg)50%}\| [nm] | 39.8 | 46.6 | Cannot be | 1,070.1 | Cannot be |
| | | | | calculated | | calculated |
| | \|[λ_{IRL(35deg)50%} − λ_{IRS(35deg)50%}] − | 49.1 | 51.4 | Cannot be | 48.0 | Cannot be |
| | [λ_{IRL(0deg)50%} − λ_{IRS(0deg)50%}]\| [nm] | | | calculated | | calculated |
| | IRP-A_{(0deg)} [% · nm] | 54.9 | 65.8 | 55.1 | 71.8 | 69.6 |
| | IRP-A_{(35deg)} [% · nm] | 46.7 | 52.9 | 40.6 | 74.6 | 72.4 |
| | IRP-A_{(35deg)}/IRP-A_{(0deg)} | 0.9 | 0.8 | 0.7 | 1.0 | 1.0 |
| | [IRP-A_{(35deg)}/VIS-A_{(35deg)}]/[IRP- | 0.9 | 0.8 | 0.7 | 1.0 | 1.0 |
| | A_{(0deg)}/VIS-A_{(0deg)}] | | | | | |
| | \|λ_{IRR(5deg)50%} − λ_{IRS(0deg)50%}\| [nm] | 88.3 | 97.1 | Cannot be | 1,117.0 | Cannot be |
| | | | | calculated | | calculated |
| | Absorption loss at 600 nm to 830 nm, | 95.6 | 92.8 | 94.1 | 0.6 | 93.2 |
| | maximum | | | | | |
| | Absorption loss at 600 nm to 830 nm, | 7,332.7 | 6,725.9 | 8,467.8 | −75.8 | 7,074.6 |
| | integration | | | | | |

From the above-mentioned results, it is understood that the optical filters of Examples 2-1, 2-2, and 2-3 are optical filters in which transmittance of visible light and near-infrared light of 950 nm to 1,200 nm is excellent, light-shielding properties of other near-infrared light in a wavelength region, particularly of 710 nm to 950 nm is excellent, and further a shift of the spectral curve is small even at a high incident angle.

In the optical filters of Examples 2-4 and 2-5 in which the light-absorbing material Y_{970S} (light-absorbing glass A) was not used, the average transmittance at 710 nm to 950 nm at an incident angle of 35 degrees exceeded 100, and the light-shielding properties in the wavelength region was particularly insufficient at a high incident angle.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-083282) filed on May 19, 2023, the content of which is incorporated herein by reference.

### INDUSTRIAL APPLICABILITY

The optical filter according to the present invention is excellent in transmittance of visible light and specific near-infrared light, and has shielding properties of other near-infrared light. In recent years, the optical filter has been useful for applications of information acquisition devices such as cameras and sensors for transport machines, for which high performance has been achieved.

### REFERENCE SIGNS LIST

1A, 1B: optical filter
10: support
20A, 20B: dielectric multilayer film
30: light-absorbing layer

What is claimed is:

1. An optical filter comprising:
a light-absorbing material λ_{700L} having a maximum absorption wavelength in a wavelength region longer than 700 nm;
a light-absorbing material Y_{970S} having a maximum absorption wavelength in a wavelength region shorter than 970 nm; and
a dielectric multilayer film, wherein
the optical filter satisfies all of the following spectral characteristics (i-1) to (i-4):
(i-1) an average transmittance T_{420-650(0 deg)AVE} is 75% or more in a spectral transmittance curve at a wavelength of 420 nm to 650 nm and an incident angle of 0 degrees, and an average transmittance T_{420-650(35 deg)AVE} is 75% or more in a spectral transmittance curve at a wavelength of 420 nm to 650 nm and an incident angle of 35 degrees,
(i-2) an average transmittance T_{710-950(0 deg)AVE} is 1% or less in a spectral transmittance curve at a wavelength of 710 nm to 950 nm and an incident angle of 0 degrees, and an average transmittance T_{710-950(35 deg)AVE} is 1% or less in a spectral transmittance curve at a wavelength of 710 nm to 950 nm and an incident angle of 35 degrees,
(i-3) a maximum transmittance T_{950-1200(0 deg)MAX} is 60% or more in a spectral transmittance curve at a wavelength of 950 nm to 1,200 nm and an incident angle of 0 degrees, and a maximum transmittance T_{950-1200(35 deg)MAX} is 50% or more in a spectral transmittance curve at a wavelength of 950 nm to 1,200 nm and an incident angle of 35 degrees, and
(i-4) |λ_{IRS(0 deg)(50%)}−λ_{IRS(35 deg)(50%)}|≤15 nm is satisfied, where
λ_{IRS(0 deg)(50%)} is a wavelength at which a transmittance is 50% in a wavelength region shorter than λ_{950-1200(0 deg)MAX} and at an incident angle of 0 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

2. The optical filter according to claim 1, wherein the optical filter further satisfies the following spectral characteristic (i-5):
(i-5) [10/[λ_{IRS(0 deg)(45%)}−λ_{IRS(0 deg)(55%)}]]|≥1.0 is satisfied, where
λ_{IRS(0 deg)(55%)} is a wavelength at which a transmittance is 55% in the wavelength region shorter than λ_{950-1200(0 deg)MAX} and at an incident angle of 0 degrees,
λ_{IRS(0 deg)(45%)} is a wavelength at which a transmittance is 45% in the wavelength region shorter than λ_{950-1200(0 deg)MAX} and at an incident angle of 0 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

3. The optical filter according to claim 1, wherein the optical filter further satisfies the following spectral characteristics (i-6) to (i-8):
(i-6) 10 nm≤|λ_{IRL(0 deg)(50%)}−λ_{IRS(0 deg)(50%)}|≤100 nm is satisfied, where
λ_{IRL(0 deg)(50%)} is a wavelength at which a transmittance is 50% in a wavelength region longer than λ_{950-1200(0 deg)MAX} and at an incident angle of 0 degrees,
λ_{IRS(0 deg)(50%)} is a wavelength at which a transmittance is 50% in the wavelength region shorter than λ_{950-1200(0 deg)MAX} and at an incident angle of 0 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-7) 20 nm≤|λ_{IRL(35 deg)(50%)}−λ_{IRS(35 deg)(50%)}|≤100 nm is satisfied, where
λ_{IRL(35 deg)(50%)} is a wavelength at which a transmittance is 50% in the wavelength region longer than λ_{950-1200(0 deg)MAX} and at an incident angle of 35 degrees,
λ_{IRS(35 deg)(50%)} is a wavelength at which a transmittance is 50% in the wavelength region shorter than λ_{950-1200(0 deg)MAX} and at an incident angle of 35 degrees, and
λ_{950-1200(0 deg)MAX} is a wavelength at which a maximum transmittance is obtained in the spectral transmittance curve at a wavelength of 950 nm to 1,200 nm and an incident angle of 0 degrees, and
(i-8) λ_{IRL(0 deg)(50%)}, λ_{IRS(0 deg)(50%)}, λ_{IRL(35 deg)(50%)}, and λ_{IRS(35 deg)(50%)} satisfy the following relational expression:
$$\vert [ {λ}_{I R L ( 35 deg ) ( 50 \% )} - {λ}_{I R S ( 35 deg ) ( 50 \% )} ] - [ {λ}_{I R L ( 0 deg ) ( 50 \% )} - {λ}_{I R S ( 0 deg ) ( 50 \% )} ] \vert \leq 70 nm .$$

4. The optical filter according to claim 1, wherein the optical filter further satisfies the following spectral characteristics (i-9) and (i-10):
(i-9) 10 (%·nm)≤IRP-A_{(0 deg)}≤100 (%·nm) is satisfied, where
IRP-A_{(0deg)} is an integral value of a transmittance in a wavelength band in which the transmittance is 20% or more in the spectral transmittance curve at a wavelength of 950 nm to 1,200 nm and an incident angle of 0 degrees, and
(i-10) 10 (%·nm)≤IRP-A_{(35deg)}≤100 (%·nm) is satisfied, where
IRP-A_{(35deg)} is an integral value of a transmittance in a wavelength band in which the transmittance is 20% or more in a spectral transmittance curve at a wavelength of 950 nm to 1,200 nm and an incident angle of 35 degrees.

5. The optical filter according to claim 4, wherein IRP-A_{(0deg)} and IRP-A_{(35deg)} Satisfy the following relational expression:
$$0.5 \leq IRP - {A}_{( 35 deg )} / IRP - {A}_{( 0 deg )} \leq 1.1$$

6. The optical filter according to claim 1, wherein the optical filter further satisfies the following spectral characteristic (i-11):
(i-11) 0.5≤[IRP-A_{(35deg)}/VIS-A_{(35deg)}]/[IRP-A_{(0deg)}/VIS-A_{(0deg)}]≤1.1 is satisfied, where
VIS-A_{(0deg)} is an integral value of a transmittance in a wavelength band in which the transmittance is 20% or more in the spectral transmittance curve at a wavelength of 420 nm to 650 nm and an incident angle of 0 degrees,
VIS-A_{(35deg)} is an integral value of a transmittance in a wavelength band in which the transmittance is 20% or more in a spectral transmittance curve at a wavelength of 420 nm to 650 nm and an incident angle of 35 degrees,
IRP-A_{(0deg)} is an integral value of a transmittance in a wavelength band in which the transmittance is 20% or more in the spectral transmittance curve at a wavelength of 950 nm to 1,200 nm and an incident angle of 0 degrees, and
IRP-A_{(35deg)} is an integral value of a transmittance in a wavelength band in which the transmittance is 20% or more in a spectral transmittance curve at a wavelength of 950 nm to 1,200 nm and an incident angle of 35 degrees.

7. The optical filter according to claim 1, wherein the optical filter further satisfies the following spectral characteristic (i-12):
(i-12) |λ_{IRR(5 deg)(50%)}−λ_{IRS(0 deg)(50%)}|≥20 nm is satisfied, where
λ_{IRS(0 deg)(50%)} is a wavelength at which a transmittance is 50% in the wavelength region shorter than λ_{950-1200(0 deg)MAX} and at an incident angle of 0 degrees,
λ_{IRR(5 deg)(50%)} is a wavelength at which a reflectance is 50% in a wavelength region longer than 950 nm and at an incident angle of 5 degrees in a spectral reflectance curve at a wavelength of 950 nm to 1,200 nm and an incident angle of 5 degrees, and
λ_{950-1200(0 deg)MAX} is a wavelength at which a maximum transmittance is obtained in the spectral transmittance curve at a wavelength of 950 nm to 1,200 nm and an incident angle of 0 degrees.

8. The optical filter according to claim 1, wherein the light-absorbing material Y_{970S} satisfies the following spectral characteristics (iii-1) and (iii-2):
(iii-1) maximum optical density at wavelength of 900 nm to 1,000 nm>0.6, and
(iii-2) a wavelength at which a transmittance is 50% on a side of a wavelength longer than the maximum optical density at a wavelength of 900 nm to 1,000 nm is in a range of 950 nm to 1,050 nm.

9. The optical filter according to claim 1, wherein the light-absorbing material Y_{970S} is an inorganic material comprising ytterbium.

10. The optical filter according to claim 1, wherein the light-absorbing material Y_{970S} is a glass comprising ytterbium.

11. The optical filter according to claim 1, wherein the optical filter comprises a light-absorbing layer comprising the light-absorbing material λ_{700L},
the optical filter satisfies both the following spectral characteristics (ii-1) and (ii-2), and
when a light is incident from a dielectric multilayer film side, an absorption loss amount_{X} at a wavelength of X nm is defined as follows,
$${( absorption loss amount )}_{X} [ \% ] = 100 - ( transmittance at incident angle of 0 degrees ) - ( reflectance at incident angle of 5 degrees ) ,$$
(ii-1) a maximum value of an absorption loss amount₆₀₀₋₈₃₀ at a wavelength of 600 nm to 830 nm is 85 or more, and
(ii-2) an integral value of the absorption loss amount₆₀₀₋₈₃₀ at a wavelength of 600 nm to 830 nm is 5,000 or more.

12. The optical filter according to claim 1, wherein the optical filter further comprises:
a substrate comprising the light-absorbing material Y_{970S},
a dielectric multilayer film A provided on or above one main surface of the substrate, and
a light-absorbing layer provided on or above the one main surface of the substrate, the light-absorbing layer comprising the light-absorbing material λ_{700L}, and
the dielectric multilayer film A satisfies the following characteristics (iv-1), (iv-2), and (iv-3):
(iv-1) the dielectric multilayer film A comprises three or more laminated structures, each of the laminated structures comprises a high refractive index layer H_{A} comprising a high refractive index material having a refractive index of 1.9 or more and 3.0 or less at a wavelength of 500 nm and a medium refractive index layer M_{A} comprising a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{A}/medium refractive index layer M_{A}), and
the medium refractive index layer M_{A} is treated as an equivalent film in a case where the medium refractive index layer M_{A} comprises the high refractive index layer H_{A} and a low refractive index layer L_{A} comprising a low refractive index material having a refractive index of 1.3 or more and 1.7 or less at a wavelength of 500 nm,
(iv-2) the dielectric multilayer film A comprises a laminated structure represented by (aₙQH_{A}/bₙQM_{A})
where QH_{A} is a QWOT of the high refractive index layer H_{A} at a wavelength of 500 nm and QM_{A} is a QWOT of the medium refractive index layer M_{A} at a wavelength of 500 nm, and
an average value of aₙ is 1.2 or more and 2.7 or less and an average value of bₙ is 1.1 or more and 2.2 or less, and
(iv-3) the number of laminated layers is in a range of 1 to 60.

13. The optical filter according to claim 1, wherein the optical filter further comprises:
a substrate comprising the light-absorbing material Y_{970S},
a dielectric multilayer film A provided on or above one main surface of the substrate, a dielectric multilayer film B provided on or above the other main surface of the substrate, and
a light-absorbing layer provided on or above the one main surface of the substrate, the light-absorbing layer comprising the light-absorbing material λ_{700L}, and
the dielectric multilayer film B satisfies the following characteristics (v-1), (v-2), and (v-3):
(v-1) the dielectric multilayer film B comprises three or more laminated structures, each of the laminated structures comprises a high refractive index layer H_{B} comprising a high refractive index material having a refractive index of 1.9 or more and 3.0 or less at a wavelength of 500 nm and a medium refractive index layer M_{B} comprising a medium refractive index material having a refractive index of 1.5 or more and 2.0 or less at a wavelength of 500 nm, the medium refractive index material has a refractive index lower than that of the high refractive index material, and each of the laminated structures is represented by (high refractive index layer H_{B}/medium refractive index layer M_{B}), and
the medium refractive index layer M_{B} is treated as an equivalent film in a case where the medium refractive index layer M_{B} comprises the high refractive index layer H_{B} and a low refractive index layer L_{B} comprising a low refractive index material having a refractive index of 1.3 or more and 1.7 or less at a wavelength of 500 nm,
(v-2) the dielectric multilayer film B comprises a laminated structure represented by (cₙQH_{B}/dₙQM_{B})
where QH_{B} is a QWOT of the high refractive index layer H_{B} at a wavelength of 500 nm and QM_{B} is a QWOT of the medium refractive index layer M_{B} at a wavelength of 500 nm, and
an average value of cₙ is 1.9 or more and 5.0 or less and an average value of dₙ is 1.2 or more and 2.9 or less, and
(v-3) the number of laminated layers is in a range of 1 to 60.

14. An imaging device comprising the optical filter according to claim 1.
